(19) United States
(12) Patent Application Publication
(10) Pub. No.: US 2016/0055442 A1
(43) Pub. Date: Feb. 25, 2016

(54) SYSTEMS AND METHODS FOR REAL-TIME ASSESSMENT OF AND FEEDBACK ON HUMAN PERFORMANCE

(71) Applicant: 1Unit, LLC., Atlanta, GA (US)

(72) Inventor: Liam Martin Chadwick, Galway (IE)

(21) Appl. No.: 14/829,873

(22) Filed: Aug. 19, 2015

Related U.S. Application Data
(60) Provisional application No. 62/039,212, filed on Aug. 19, 2014.

(51) Int. Cl. G06Q 10/06

(52) U.S. Cl. CPC G06Q 10/06398

(57) ABSTRACT

In an example implementation of the disclosed technology, a method includes receiving one or more performance related criteria relating to an individual's performance of a particular task and, in response, generating an assessment template that comprises information indicative of the one or more performance related criteria. The method further includes outputting, for display at a computing device, the assessment template and receiving, from the computing device, information indicative of one or more responses relating to the one or more performance related criteria. The method also includes storing the information indicative of one or more responses relating to the one or more performance related criteria and, responsive to receiving an indication of a request for a results dashboard, generating the results dashboard. Finally, the method includes outputting, for display at the computing device, the results dashboard.

### CROSS REFERENCE TO RELATED APPLICATIONS

This application claims priority under 35 U.S.C. §119(e) to, and the benefit of U.S. Provisional Patent Application No. 62/039,212, filed Aug. 19, 2014, entitled “SYSTEMS AND METHODS FOR REAL-TIME ASSESSMENT OF AND FEEDBACK ON HUMAN PERFORMANCE,” the entirety of which is hereby fully incorporated by reference as if set out in its entirety below.

### TECHNICAL FIELD

The present systems and methods relate generally to human performance assessment. In particular, the present systems and methods allow for the assessment of a performed task or provided service and the provision of feedback relating to the assessment.

### BACKGROUND

Because human error has been shown as a significant contributing cause of accidents, many modern industries (e.g., aviation, power generation, etc.) have sought to remove the human element from their processes and systems. For example, just a sample of studies have shown human errors being attributed to nearly 90% of highway traffic accidents, at least 80% of anaesthesia accidents, and 60% of all medical device-related deaths or injuries in the United States. Ultimately the management, control, and operation of certain industries and their processes remain dependent on some human component or element within their system. This is particularly true in complex, high-risk, or emergency situations where human experts must intervene when the limits of defined-boundary conditions are neared (or reached) to bring the system or process back under control.

Human Factors Engineering (HFE) is the field of research that examines human performance. Understanding human performance is a basic premise in comprehending human operators' ability to perform their tasks, activities, or processes. Features of these operators' abilities to complete their tasks, activities, or processes, such as their accuracy, reliability, timeliness, minimized variation, etc., can then be analyzed to determine a system's functionality and integrity in light of the human elements required by the system.

Human elements are also often the driving force behind the customer satisfaction in a service-driven industry. The success of service industries is not only dependent on the quality of the service product, but on the quality of those delivering the service. Irrespective of whether a service is delivered face-to-face or online, customer satisfaction and customer loyalty become fundamentally dependent on customer interactions with staff members. In general, in the context of the present disclosure, a service provider is not necessarily limited to a business-to-customer relationship and set of interactions, but may also incorporate inter-organizational (e.g., business-to-business) and intra-organizational (e.g., department-to-department) relationships and interactions.

For example, in healthcare industry, it often is not the clinical outcomes that have the greatest impact on patients' satisfaction. Instead, it has been described that patients have in mind a particular sense or standard of how a person should be treated, and they judge their experience according to this mental image. Studies have found that a health care provider's attitude and behavior is just as important to a patient as the practitioner's medical skills. In fact, studies show that the practitioner's bedside manner (e.g., their warmth, interaction, willingness to answer questions, willingness to take the patient's perspective into account) typically correlates to a patient's perception of the practitioner's care. In fact, doctors with poor communication skills and poor bedside manner, irrespective of clinical competency, are typically named as defendants in litigation more so than their counterparts.

Accordingly, it is often the non-technical skills based competencies (e.g., touch, communication, body language, attitude, disposition, etc.) of individual service operators and providers that are increasingly important to customer satisfaction and loyalty, which generally yields potential business growth. To help ensure organizational success, it is more and more important to be able to assess service operators or providers with respect to these aspects of service delivery from the customer's perspective.

Proactive HFE analysis techniques typically are dependent on the decomposition of complex tasks, activities, goals, and processes into smaller discrete sub-tasks, sub-activities, sub-goals and sub-processes (i.e., “sub-components”). Using a standardized set of taxonomies or specific assessment criteria, these sub-components can be analyzed for the potential of human error occurrence or to examine the effects of system failures on goal completion. Typically, these methods are so-called “table-top” analysis methods that do not extend to real-time, real-world assessments. Alternatively, retrospective HFE analysis techniques (e.g. video analysis or trend analysis) examine events that have already occurred, thus missing the opportunity to regain control of the system prior to a potential adverse event occurrence.

In general, feedback is the attention given to specific behaviors with the intent of guiding future performance. Typically, feedback is most valuable when delivered within minutes of the observed behavior and should be specific with respect to its content. Traditionally, neither the typical retrospective or proactive approaches to HFE analysis have functioned particularly well in real-time and therefore have had very limited ability to provide immediate feedback to the human personnel completing the tasks, activities, or processes being observed.

Both retrospective HFE- and proactive HFE-type analysis techniques do, however, provide extensive information to facilitate the development of Performance Assessment Criteria (PACs). In general, PACs are expert-derived and agreed upon codified, objective measures of the operator's, worker's, or employee's completion of a task, goal, process, activity, or work function, or their decomposed sub-components, irrespective of whether these are formally recorded, or informally generated, local rules. Thus, generally speaking, when a task requires a series of steps, a series of PACs, each explicitly defining an aspect of a step (e.g., timeliness, tone of communication), can be used to evaluate someone's performance of the task. As used herein, for convenience, a PAC may be referenced as relating to the performance or completion of a particular task, but this usage is not intended to be limiting in any way. It is to be understood that a PAC can relate to performance or completion of any task, goal, process, activity, or other work function. Accordingly, PACs can be used to assess the human operator's completion of the required tasks, activities, or processes (or their sub-components) in real-time. Using task, activity, goal, or process decomposition, followed by the development of specific PACs, it is possible to assess operators' performance in real-time against a set of these codified objective metrics. In general, this enables assessors to certify individuals through the completion of real-time evaluations of the individuals completing their required duties.

Generally, in addition to evaluating their own employees, organizations can define PACs for customers to assess the employees (i.e., the service providers or operators) in relation to the service in which they are engaged and that is provided to the customers. But, an organization may also seek to elicit customer PACs regarding the provided service. Eliciting such customer-based perceptions can be vital to continually improving the customer experience and ensuring long-term customer satisfaction and loyalty.

Typically, PACs need to be made known to service providers and included in their training for organizations to begin evaluating service provider performance. Further, to gain a deeper understanding of customer satisfaction or dissatisfaction, it is generally necessary for an organization to make PACs available to customers so customers can evaluate the service they receive.

Real-time feedback of customer-based performance assessment information to service providers, trainers, managers, and leadership facilitates the ability of the organization to self-correct, continually improve, and to meet and anticipate customer needs. Furthermore, this feedback often allows service providers to self-reflect on particular aspects of their performance, thereby facilitating continuous personal improvement. For example, a combination of positive PAC feedback, descriptive text, and answers to direct questions can potentially boost service provider self-confidence and self-efficacy, thereby resulting in self-sustaining cycle of improved positivity, customer engagement, and service delivery.

To date, the technology to support such real-time assessment has not been developed, and thus the opportunity to perform codified objective performance assessment has been missed. Because such technology has not existed, the opportunity has been overlooked to turn real-time performance-based assessment into a form of competency, training, or performance certification for staff, which could signify a uniform level of competence regarding that task, activity, or process. Aspects of the present disclosure seek to address such deficiencies.

### BRIEF SUMMARY OF THE DISCLOSURE

Briefly described, and according to some embodiments, aspects of the present disclosure generally relate to systems and methods for real-time assessment of human operators based on performance assessment criteria (PACs)and the recording and display of assessments for either real-time or retrospective review. In particular, the present disclosure describes the technology used to complete and record performance assessments of operators or service providers. In some embodiments, each operator-based task, activity, or process can be evaluated by an assessor with respect to the operator's completion of the required task, activity, or process. For service-orientated industry, the assessors can sometimes be customers who received the service. In some embodiments, an assessor completes an evaluation using a set of predetermined and defined PACs that can embodied as an Assessment Template (AT) for that task, activity, or process.

According to some embodiments, aspects of the present disclosure may comprise software that may exist as a desktop tool, an internet-based application, or a mobile computer application (e.g. tablet or mobile phone application). In one implementation, a variety of these mediums could be used to define, complete, record, and display the information as feedback or performance tracking.

PACs may exist in a single dimension, or on multiple dimensions. In some embodiments, PACs can be collectively grouped into Assessment Templates (ATs) associated with a particular task, activity, or process. Different ATs may exist for each individual operator role involved in the completion of a task, activity, or process. Alternatively, a single AT may comprise various PACs applicable to several operator roles necessary for completing a particular task. Similarly, team- or group-level PACs may be defined and attributable if the activity being assessed is team-oriented and/or if team-specific PACs have been defined.

In some embodiments, an AT can be embodied in electronic form such that an evaluator can engage or interact with the AT via a computing device such as a laptop computer, tablet computer, smartphone, desktop computer, or other suitable computing device. As will be understood, many programming methods can be utilized to aggregate one or more PACs into an AT. For example, in one embodiment, custom XML-formatted code files can be used to create electronically embodied AT. For example, in some embodiments, XML-formatted code files could define: an AT title; a percentage mark (i.e., a percentage of successfully completed PACs) required for an assessment to be considered a “pass” or “competent”; the dimensions of the AT; and which PACs are associated with each dimension. As will be understood, the foregoing are provided as examples and in no way are intended to be limiting. In some embodiments, the XML-formatted code files (or similar files) can be used to create database records and underpin user interfaces for engaging or interacting with the AT.

Evaluation and assessment may be completed in real-time (e.g., via a computing device) with or without supplemental audio and/or video recording, according to some embodiments. Accordingly, a task, activity, or process could be recorded and analyzed using aspects of the present disclosure at a later time. In some embodiments, the assessed or unassessed recording may or may not be made available to an operator for later review, as deemed appropriate by the assessor or management.

In some embodiments, PAC results may be displayed depending on the number of dimensions used (e.g., single line plots (see FIG. 1), x-y plots (see FIG. 2), etc.). Summary results may be displayed for each dimension using absolute, relative, percentage, or other scores achieved on the results display (e.g., see FIG. 1 and FIG. 2). Aggregated results may be displayed to provide information about a group or team of operators. This information may be particularly useful to team or group leaders, managers, trainers, accreditors, certifiers, etc.

As will be understood and appreciated, particular implementations of the disclosed technology may realize one or more of the following advantages: through the use of the disclosed technology, codified objective operator performance assessments can be completed in either real-time or retrospectively, and can be completed using audio and/or video analysis; specific results and summary results may be available for operators, customers, assessors, leadership, trainers, accreditors, certifiers, or others, thus ensuring operators are completing their tasks, activities, or processes accurately, reliably, timely, and with minimized variation, thereby exhibiting competence, process compliance, protocol adherence, understanding, and/or achievement of required quality, safety, or customer satisfaction levels.

These and other aspects, features, and benefits of the disclosed technology will become apparent from the following detailed written description of the various embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a one-dimension binary-type horizontal results display, according to an example embodiment.

FIG. 2 illustrates a team-based, two-dimension, three-scale X-Y plot display, according to an example embodiment.

FIG. 3 is a representation of an assessment process, according to an example embodiment.

FIG. 4 is a sample Likert Scale, according to an example embodiment.

FIG. 5 is a sample Graphic Rating Scale, according to an example embodiment.

FIG. 6 is a sample one-dimension, 10-criterion PAC, binary-based Assessment Template, according to an example embodiment.

FIG. 7 is a sample two-dimension, 10-criterion PAC, three-scale Assessment Template, according to an example embodiment.

FIG. 8 is a sample alternative result plot layout, according to an example embodiment.

FIG. 9 is a sample list of completed assessments from an assessor's view, according to an example embodiment.

FIG. 10 is a sample list of completed assessments from an operator's view, according to an example embodiment.

FIG. 11 is a sample results comparison plot for a first operator, according to an example embodiment.

FIG. 12 is a sample results comparison plot for a second operator, according to an example embodiment.

FIG. 13 is a sample list of completed assessments from a service provider or operator's view, according to an example embodiment.

FIG. 14 is a sample list of completed assessments from an assessor or manager's view, according to an example embodiment.

FIG. 15 is a sample home view of a Tracking Dashboard, according to an example embodiment.

FIG. 16 is a sample dimension one view of a Tracking Dashboard, according to an example embodiment.

FIG. 17 is a representation of a sample process for direct question evaluations, according to an example embodiment.

FIG. 18 is a sample direct question and customer input, according to an example embodiment.

FIG. 19 is a representation of a sample process for text or audio/video evaluations, according to an example embodiment.

FIG. 20 is a sample customer interface for descriptive text evaluations, according to an example embodiment.

FIG. 21 is a sample customer interface for audio/video evaluations, according to an example embodiment.

FIG. 22 is a sample HTA diagram for “hand hygiene” (soap and water), according to an example embodiment.

FIG. 23 is a sample “hand hygiene” one-dimension Assessment Template, according to an example embodiment.

FIG. 24 is a sample hand hygiene results display, according to an example embodiment.

FIG. 25 is a sample ‘hand hygiene’ Tracking Dashboard, according to an example embodiment and showing a sample comparison of individual operator's results with hospital and global performance, according to an example embodiment.

FIGS. 26A and 26B are a sample HTA diagram of ‘prepare the aircraft for landing’, according to an example embodiment.

FIG. 27 is a sample assessment template with ‘radio button’ selectors for ‘Prepare aircraft for landing’, according to an example embodiment.

FIG. 28 is a sample assessment results for ‘prepare aircraft for landing’ task, according to an example embodiment.

FIG. 29 is a sample ‘prepare aircraft for landing’ Tracking Dashboard, according to an example embodiment.

FIGS. 30A-30C are a sample HTA diagram of ‘preparing equipment for a shallow scuba dive,’ according to an example embodiment.

FIG. 31 is a sample assessment template for ‘complete pre-dive final checks,’ according to an example embodiment.

FIG. 32 is a sample assessment results for ‘complete pre-dive final checks with a buddy,’ according to an example embodiment.

FIG. 33 is a sample ‘complete pre-dive final checks with a buddy’ tracking dashboard, according to an example embodiment.

FIGS. 34A-C are a sample assessment template for teaching trainee how to attach the regulator to the air tank valve, according to an example embodiment.

FIGS. 35A and 35B are example performance dashboards relating to the task of teaching trainees how to attach the regulator to the air tank valve, according to an example embodiment.

FIG. 36 is an example IT configuration, according to an example embodiment.

### DETAILED DESCRIPTION

Aspects of the present disclosure will be described more fully hereinafter with reference to the accompanying drawings, in which some, but not all embodiments of the disclosure are shown. Indeed, aspects of the present disclosure may be embodied in many different forms and should not be construed as limited to the embodiments set forth herein; rather, these embodiments are provided so that this disclosure will satisfy applicable legal requirements. Like numbers refer to like elements throughout.

### System Overview

In some embodiments, the disclosed system may be maintained by an administrator who has access to all records maintained by the system. For example, in some embodiments, operators can register or be registered for the system using a set of pre-defined registration details. The information entered during registration typically forms the basis of a profile for each registered operator in the system, which may provide background information to the assessor about the operator, as well as information about previous performance assessments completed for that individual operator. Operators can log into the system, and thus their profile, to view performance feedback, or the feedback can be pushed to the operator in a preferred format (e.g. email, text message, etc.).

In some embodiments, the system may allow an assessor to see historical performance assessment data for an individual operator. As will be appreciated, this may facilitate the comparison of historical performance against recent performance, and such information may be used to determine whether particular operators require a new assessment. For example, in some embodiments, the system may provide an assessor with alerts or reminders that a particular operator is in need of an updated assessment. Alternatively, an assessor may determine an updated assessment is required based on review of an operator's completed assessments. In general, any registered operator is available for selection in the system for assessment.

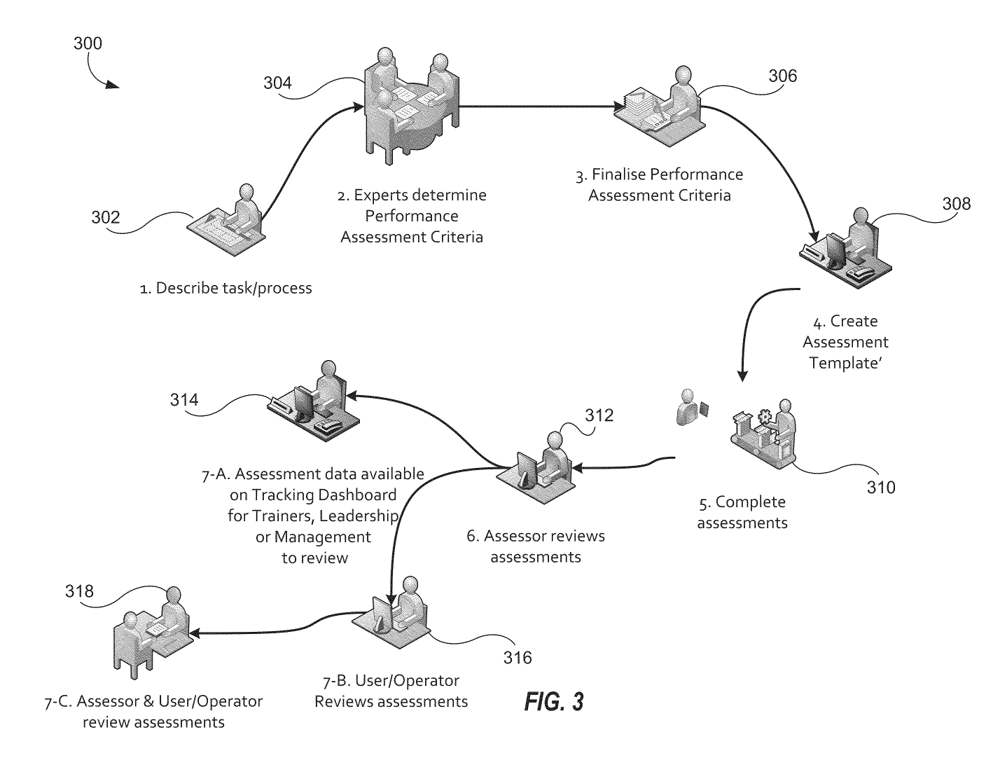

FIG. 3 shows an example representation of an assessment process 300, according to some embodiments. As shown, in some embodiments, at 302, assessors or other officials describe a particular task. Accordingly, various experts and officials may determine the appropriate PACs associated with the particular task, at 304. Subsequently, in some embodiments, an assessor or other official may finalize the PACs, at 306, and then create an AT relating to the particular activity, at 308. As will be understood and appreciated, the AT relating to the activity comprises the PACs associated with the activity. In some embodiments, an assessor may use an AT to complete an assessment of an operator performing the particular task, at 310, and then one or more assessors may review the assessment, at 312. In some embodiments, at 314, the assessment data relating to the operator's performance of the particular task is then available on a Tracking Dashboard for review by various trainers, managers, team leaders, or others. Further, the assessment data relating to the operator's performance may be available for the operator to review, at 316. In some embodiments, the assessor and operator may review the assessment data in concert such that the assessor can provide feedback information to the operator, at 318. As will be understood and appreciated, once the PACs have been determined, assessments can occur as often as is necessary. In some embodiments, the system may aggregate information generated in each assessment and share the aggregated information automatically or at predetermined intervals.

In some embodiments, once the process stakeholders (i.e., management, assessors, experts, and various other process stakeholders) have finalized the PACs relating to a particular task, the PACs may be formally recorded into the system as an AT, which may include an appropriate title (e.g., Criteria for Hand Washing Prior to Surgery). When creating an AT, according to some embodiments, it may be necessary to set the number of dimensions to be used in the AT (e.g., one or more) in addition to other details. As will be understood by one of skill in the art, dimensions can refer to the grouping or categorization of PACs into a common theme or themes. For example, in some embodiments, dimensions could be the grouping or categorization of PACs related to task duration, quality, accuracy, communication style, use of body language and/or touch, explanation of task status, maintaining prescribed task pacing, and other factors. After determining these specifics, the individual assessment criterion and its attributes can be defined in terms of the assessment scale: criterion title (e.g., ‘washed back of hands’); whether the criterion is to be measured using a binary (e.g., yes/no, true/false, etc.) or multi-level (e.g., 0-2, 0-5) scale; if the criterion is weighted; and various other definable attributes.

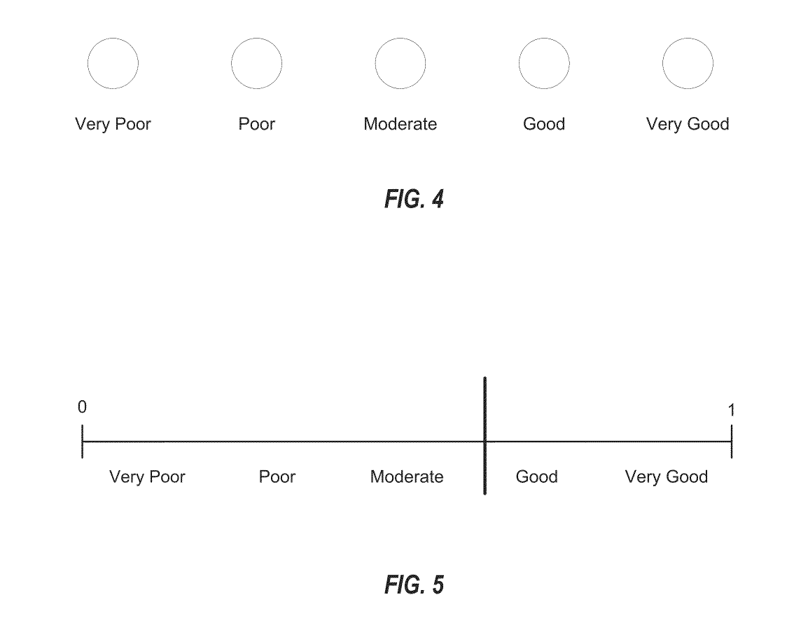

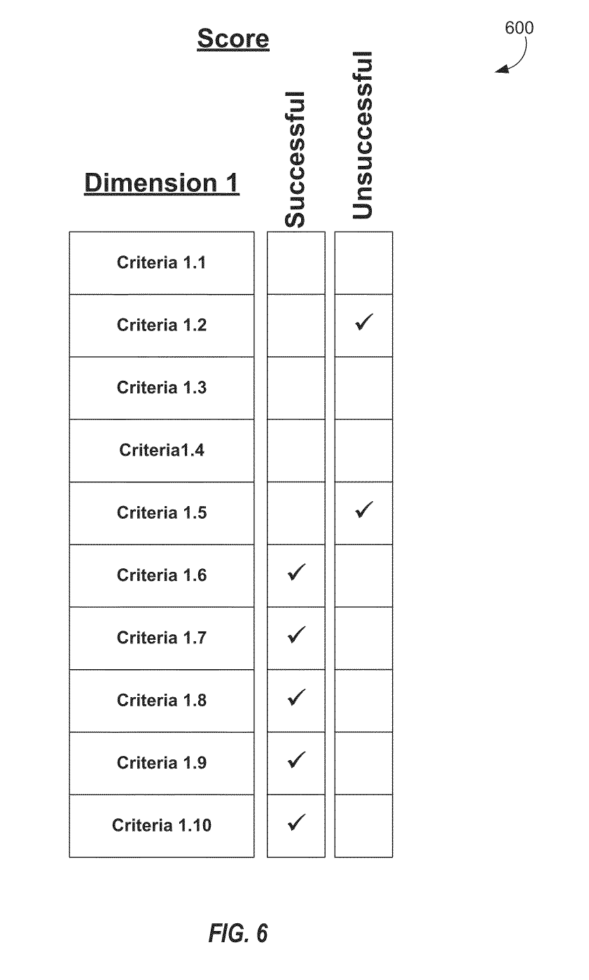

According to some embodiments, Assessment Scales may take the form of Likert-type whole value selections (as shown in FIG. 4), proportional values, such as Graphic Rating Scales (as shown in FIG. 5), or other forms as appropriate. PACs may be selected in the system using a variety of displays, which may include buttons, switches, knobs, dials, drop down lists, sliding scales, or various other inputs, depending on the applicability of the selection method relative to the value type being selected. FIG. 6 shows an example AT, according to some embodiments, using a single dimension, 10-criterion PAC, measured using a binary ‘successful/unsuccessful’ button selection.

In some embodiments, High-Performance PACs, or even Low-Performance PACs, may be weighted relative to basic performance assessment criteria resulting in a positive or negative multiplier effect, thus indicating the relative importance or criticality of the criteria to the overall task, activity, or process, as applicable. According to some embodiments, an equation to calculate the ‘Total Score’ for each dimension can be defined within the system to automatically calculate and account for the weighted PAC. Weighted PACs may be graphically coded (e.g., with color or hatching) to better differentiate the relative weight or importance of individual criteria during the process of selection and/or when displaying results.

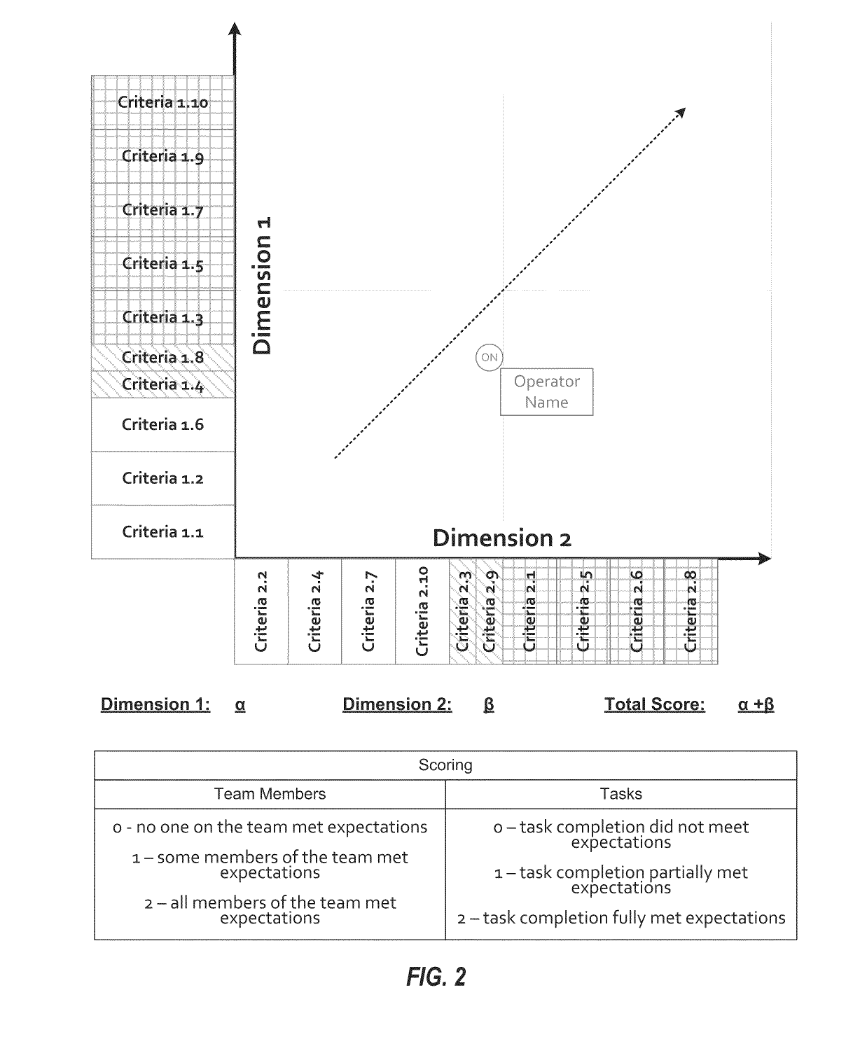

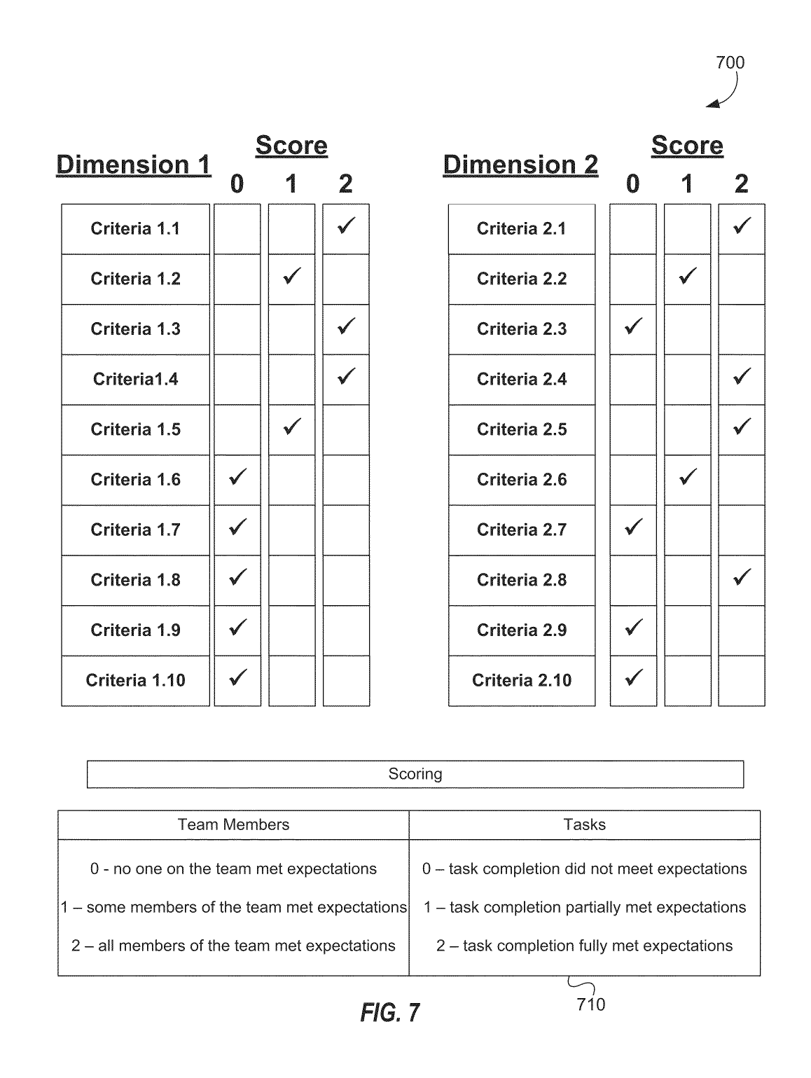

In some embodiments, if PACs are assessed using a scale (e.g., 0-2), the subsequent results output may aggregate the total score for each criteria, thereby producing the total score for the dimension. FIG. 7 shows an example two-dimension, 10-criterion PAC, three-scale (0-2) AT. FIG. 2 shows an associated potential results display in which it can be seen that the box-hatched criteria indicate the criteria that have not been achieved and non-hatched criteria are twice the width of the line-hatched criteria, denoting a double weighting of non-hatched criteria or score relative to line-hatched criteria. Thus, as will be understood and appreciated, in some embodiments, certain results can be weighted more heavily than others.

In some embodiments, when each criterion for each dimension has been defined, the completed assessment template can be saved with its title. The template is then available for use within the system for those operators or assessors whose roles include the permissions to complete assessments. According to some embodiments, ATs can be stored in a database for desktop, laptop, tablet, or similar configurations accessed via the internet, but ATs can also be saved to the local device if using a tablet computer, smart phone, or similar computing device as part of the software application to support functioning without an internet connection.

The ability to complete assessments may be assigned to specific registered operators or assessors, and a system administrator may associate certain permissions to the registered operators or assessors that allow them to access PACs. Additionally, in some embodiments, various roles may be defined in the system as having the ability to complete assessments. For example, a “Trainer” role might be created that would only allow assessors to create and save new assessments. In some embodiments, however, these assessors might be specific front-line operators, customers, or managers. System roles may be defined in the system by the system administrator and assigned to operators as applicable. As will be understood and appreciated, this allows for an interlock in the system that prevents staff from self-assessing or certifying themselves.

In some embodiments, the system may record the date and time at which an assessment begins. The assessor may select which registered operator is to be assessed. The assessor may select which of the predetermined and defined ATs is to be used for the current assessment from the list of existing ATs. Upon template selection, in some embodiments, the associated PACs are displayed using the specified display type (e.g., button, switch, or other display type). Accordingly, the assessor may then observe the operator completing the task, activity, or process, and using the technology system in real-time, the assessor may select which of the PACs have been sufficiently demonstrated as being successfully completed.

According to some embodiments, once the task, activity, or process is completed, the assessor may instruct the system to save the assessment. Assessment results may be immediately available for review by the assessor. These results can also be shared with the individual operator, team, or manager as applicable. In some embodiments, results may be stored in a local database or a networked database. For example, results may automatically be stored to the networked database once a connection to the database has been established. The database may be backed up at regular intervals to ensure data integrity and availability.

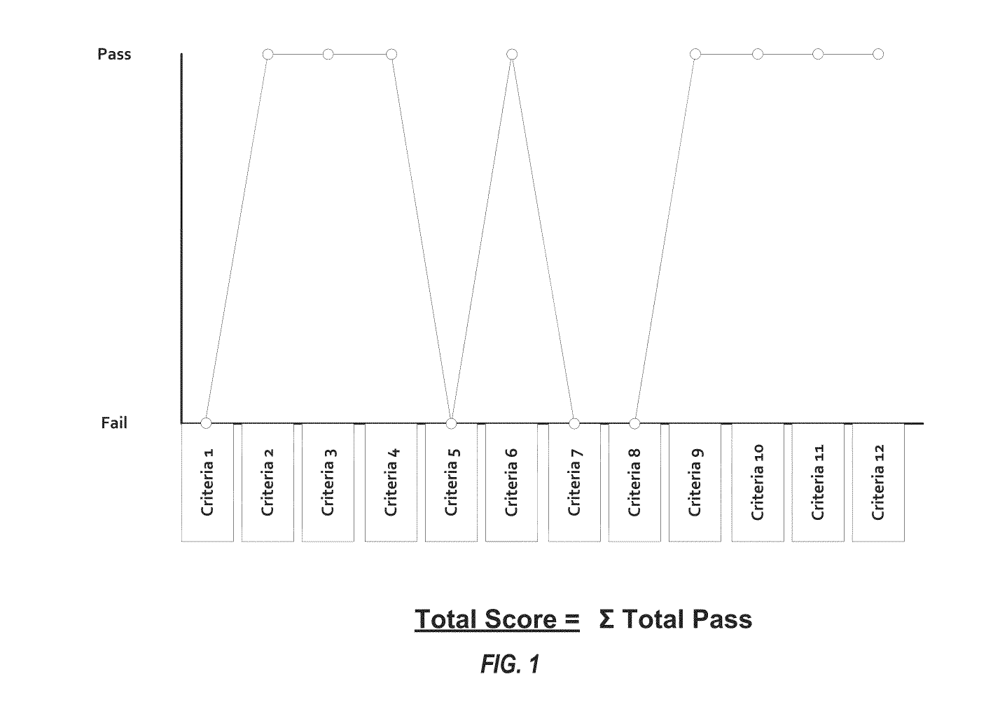

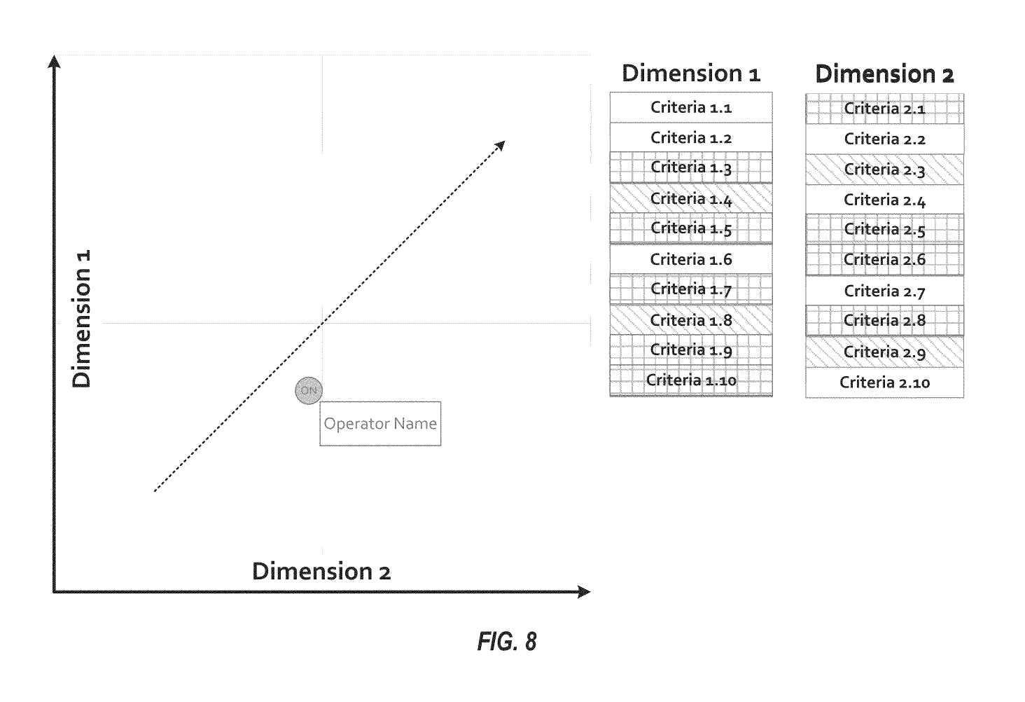

In some embodiments, assessment results can be displayed based on the number of dimensions utilized in the assessment, as defined according to the AT (see, e.g., FIG. 1 and FIG. 2). The layout of the result plots may vary depending on the system configuration (see, e.g., FIG. 8), which shows the results in a landscape format with the results plot and assessment criteria shown side-by-side rather than above and below each other.

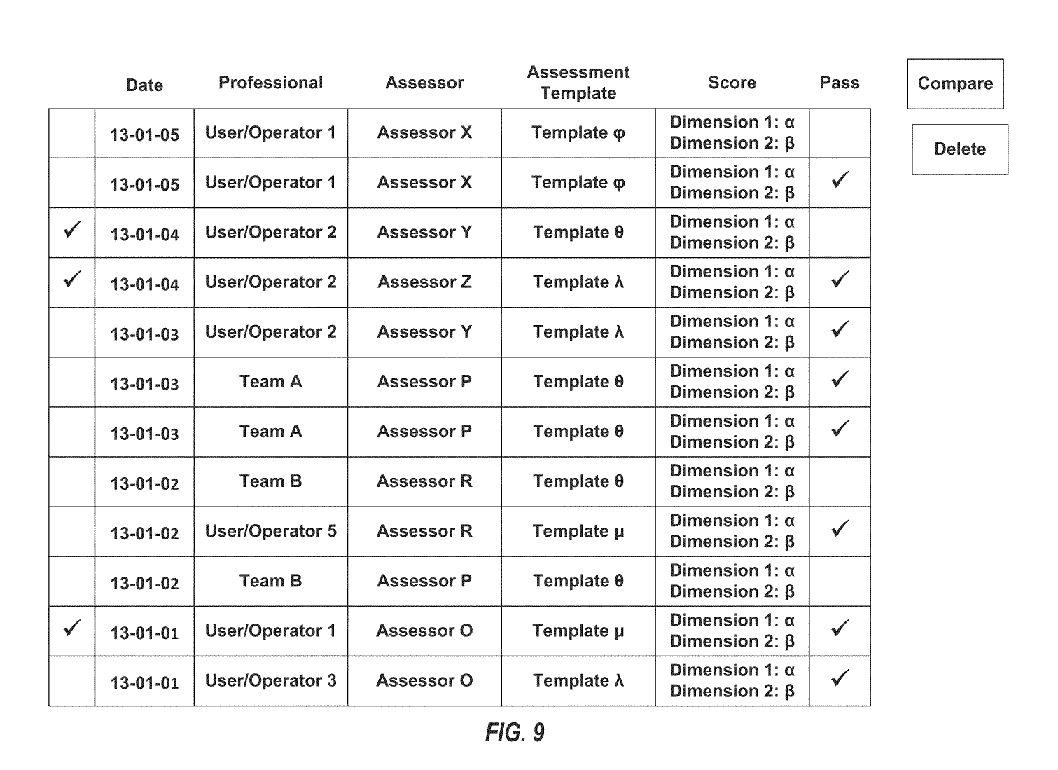

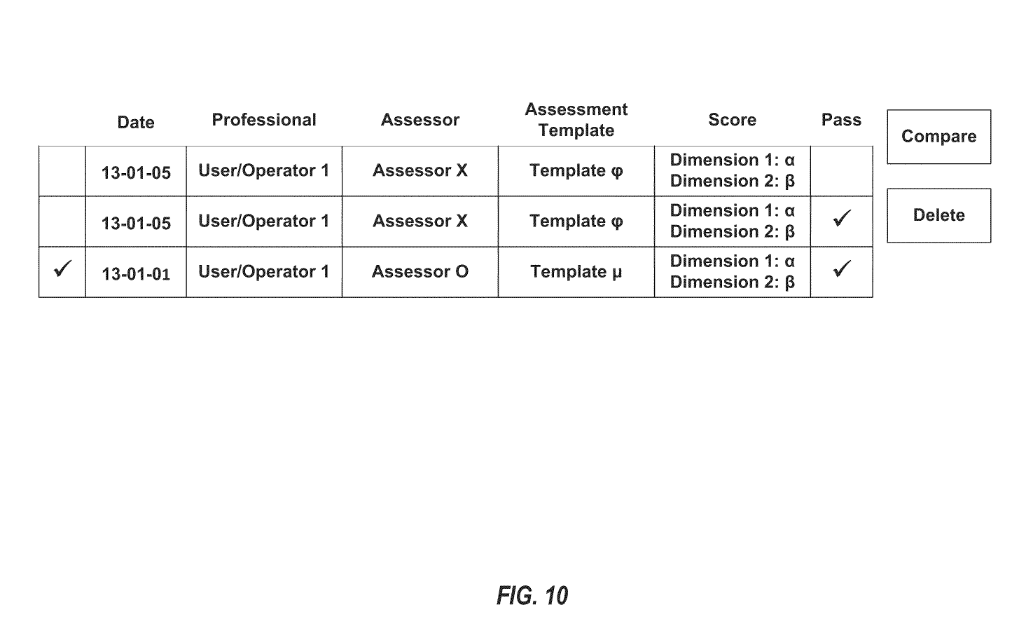

In some embodiments, the system may provide to assessors a table of all completed assessments stored in the system (see, e.g., FIG. 9), and the system may provide to operators a table for their completed assessments (see, e.g., FIG. 10). In some embodiments, the system can be configured to assign a “pass” mark to an assessment automatically if a pre-approved value has been specified. Alternatively, assessors can manually mark assessments as “pass” using either the table of completed assessments or the individual assessment's results page. In some embodiments, the system can be automated to “certify” an operator's performance based on established rules (e.g., an operator achieved five “pass” assessments in a 24-hour period). Alternatively, in some embodiments, “certification” may be manually awarded by assessors.

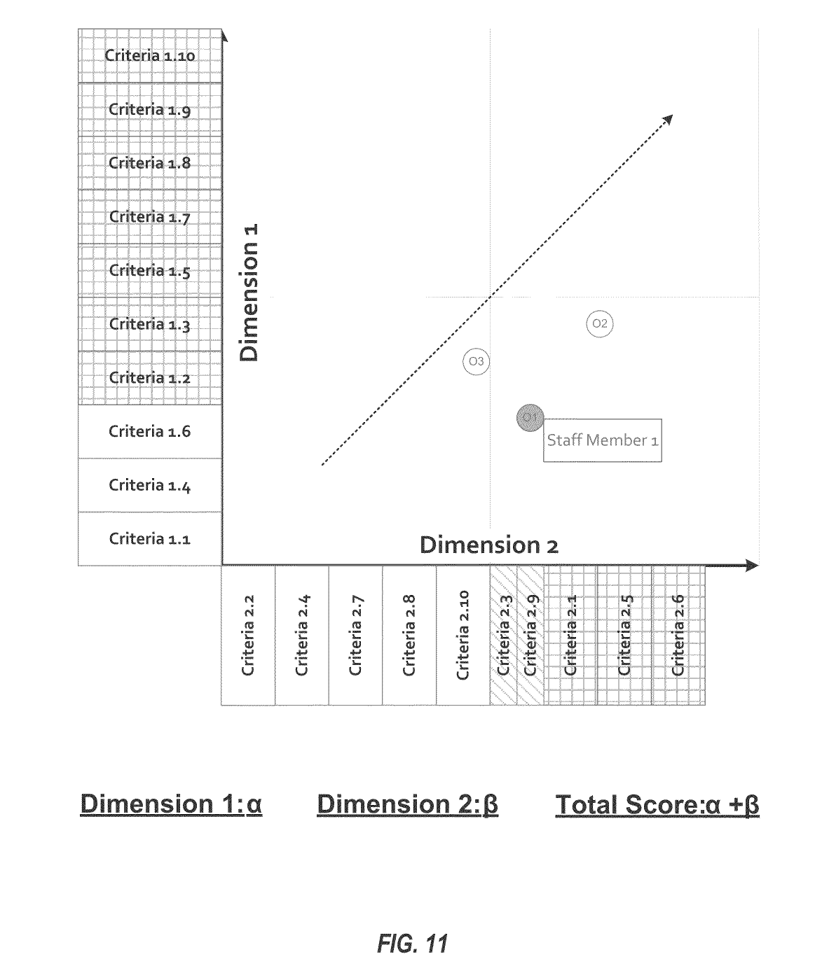

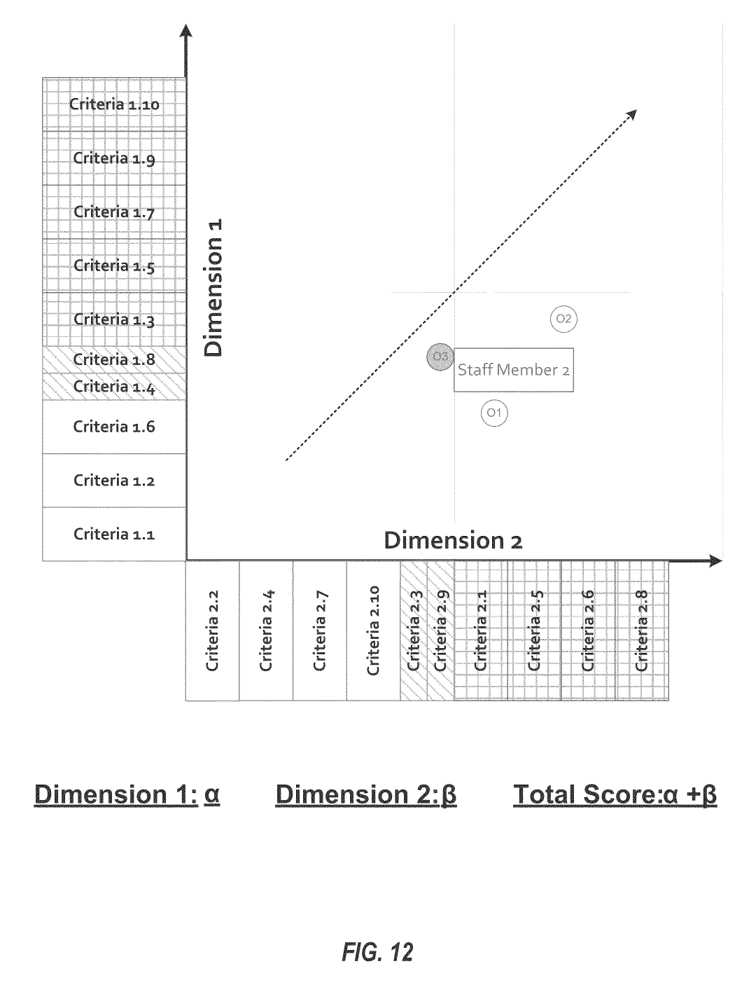

In some embodiments, assessors may compare the results of different assessments for different individuals or teams that were completed using the same ATs, which allows for a like-by-like comparison. Optionally, in some embodiments, comparing assessments can occur by displaying the chosen completed assessments on the same plot, thus allowing the assessor or operator to benchmark performance to self, other individuals, or averages of other individuals. In some embodiments, selecting each assessment result indicator on the results plot displays the results for that specific assessment, which may enable the review of the individual PAC achieved or not achieved. For example, FIG. 11 displays assessment results for staff member 1, while FIG. 12 displays assessment results for staff member 2 from the same comparison plot, according to some embodiments. As can be seen in FIGS. 11 and 12, certain criteria on the x- and y-axes are weighted differently from others, which can indicate the weight and importance given to those criteria when assessing a particular staff member. For example, in FIG. 11, Criteria 2.2, 2.4, 2.7, 2.8, and 2.10 are shown with no hatching indicating that they were assessed as being successfully completed by the service operator or provider, Criteria 2.3 and 2.9 are shown with cross hatching, indicating they were observed as being only partially completed, and Criteria 2.1, 2.5, and 2.6 are shown with square hatching, indicating they were not observed as having been completed. As further shown in FIG. 11, on the y-axis, Criteria 1.1, 1.4, and 1.6 are shown with no hatching, indicating that they were assessed as being successfully completed by the service operator or provider, and the remaining criteria are shown with square hatching, indicating they were not observed as having been completed. In FIG. 12, on the x-axis, Criteria 2.2, 2.4, 2.7, and 2.10 are shown with no hatching, Criteria 2.3 and 2.9 are shown with cross hatching, and Criteria 2.1, 2.5, 2.6 and 2.9 are shown with square hatching. As further shown in FIG. 12, on the y-axis, 1.1, 1.2, and 1.6 are shown with no hatching, Criteria 1.4 and 1.8 are shown with cross hatching, and Criteria 1.3, 1.5, 1.7, 1.9, and 1.10 are shown with square hatching. In some embodiments, the varying hatching indicates the emphasis given to a particular criteria for an assessment of a staff member. In the foregoing example, the hatching scheme in FIG. 12 is similar to that used in FIG. 11, though it will be appreciated that many different hatching schemes can be used to indicate the weight or importance given to various criteria.

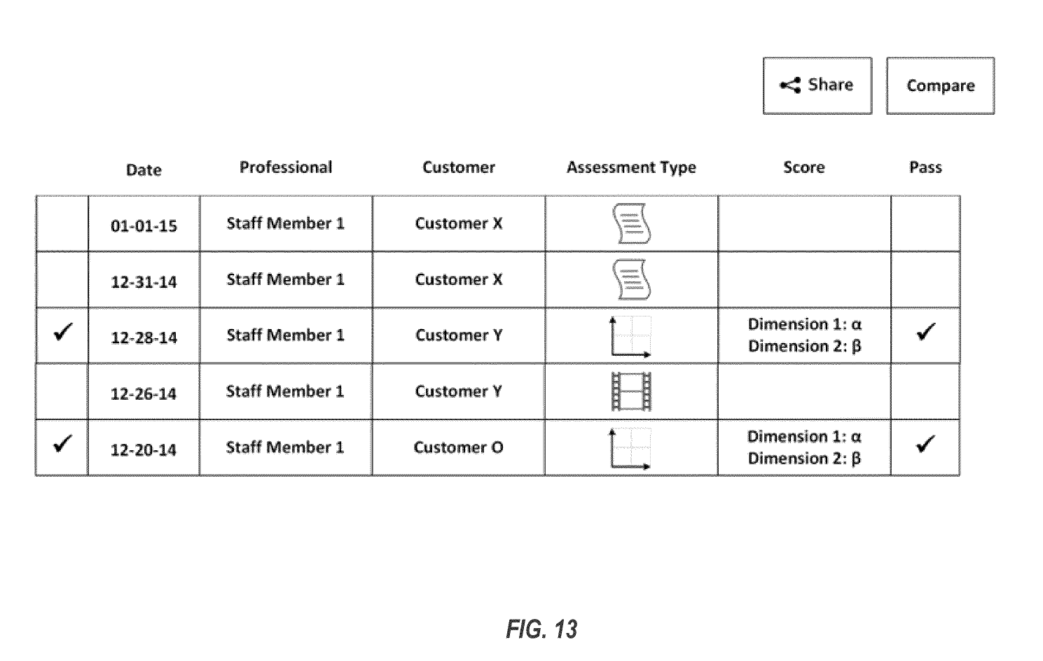

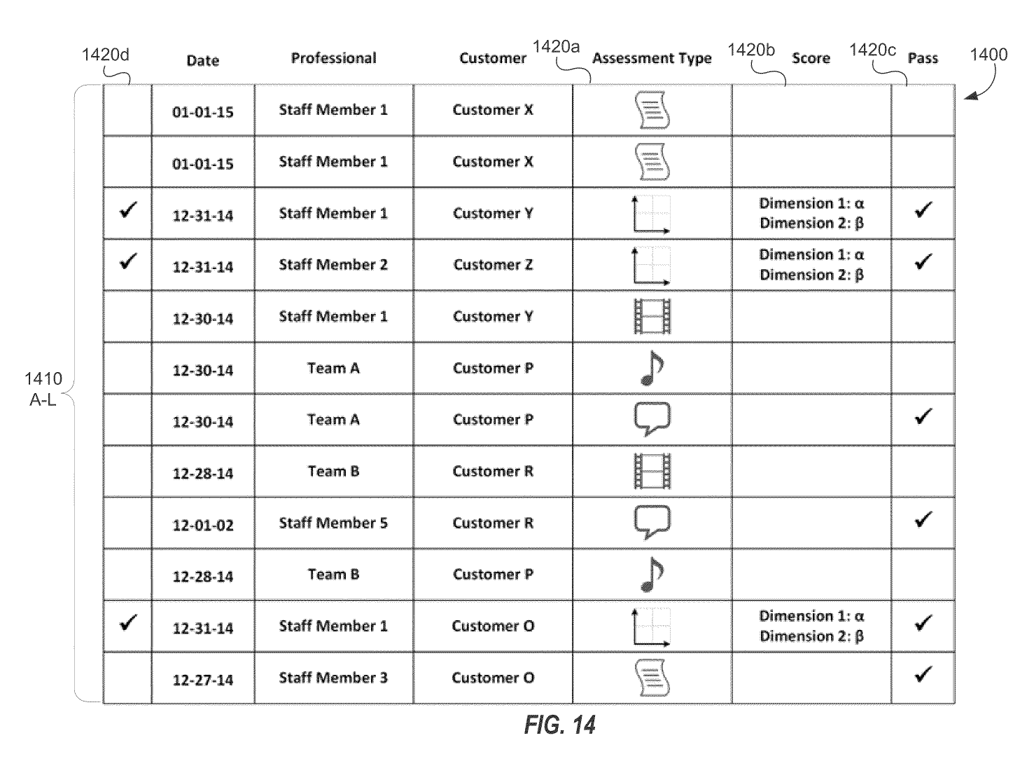

In some embodiments, assessors may be customers who are assessing the service operators (see, e.g., FIG. 13 in which a Service Provider such as a staff member can see the various assessments completed for them by different customers). As will be appreciated, completed customer assessments can be presented to trainers, managers, leadership, and others as appropriate. For example, FIG. 14 shows an interface 1400 for interacting with completed assessments. According to some embodiments, and as shown in FIG. 14, each row 1410A-1410L relates to a particular assessment. So, for example, as shown in the first row 1410A, Customer X completed an assessment relating to Staff Member 1 on Jan. 1, 2015. Further, in some embodiments, each row of the interface 1400 may contain additional information relating to an assessment. For example, in some embodiments, an interface 1400 may include a column 1420a for the type of assessment (e.g., using an AT-based evaluation, audio feedback, video feedback, multiple-choice service provider evaluation, or other assessments), a column 1420b for the assessment score (e.g., score for each AT dimension, number of multiple-choice questions with a score above a specified “pass” threshold, or other scores), and a column 1420c indicating whether the professional passed or failed the assessment.

Additionally, in some embodiments, using the interface 1400, managers or other personnel can compare the results of multiple assessments. For example, as shown in FIG. 14, a user with the appropriate permissions (e.g., trainer, manager, executive leader) can, in column 1420d, select various similar assessments to compare. For example, the user can compare AT-based evaluations or can compare multiple-choice question results. Service providers (e.g., trainees) may compare the results of different assessments that have been completed for them. For example, in some embodiments, service providers can compare their results to their peers' results. In some embodiments, service providers can compare their results to team/organization averages that were generated using the same ATs, thus allowing a like-by-like comparison. Optionally, in some embodiments, chosen assessments can be displayed on the same plot so that they can be compared and thus allowing the service providers, trainers, or leadership to benchmark performance relative to self, other individuals, or averages of other individuals. In some embodiments, when a user selects an assessment result indicator from the list of completed assessments, the system can generate and output for display the results for that specific assessment, thus enabling the review of the individual PAC achieved or not achieved. For example, as shown in FIG. 14, rows 3 and 10 are selected for Staff Member 1 and row 4 is selected for Staff Member 2, which can then be displayed as per FIG. 11, which displays assessment results for Staff Member 1, and FIG. 12, which displays assessment results for Staff Member 2 on the same comparison plot. As will be appreciated, the PAC changes according to the results for each completed assessment.

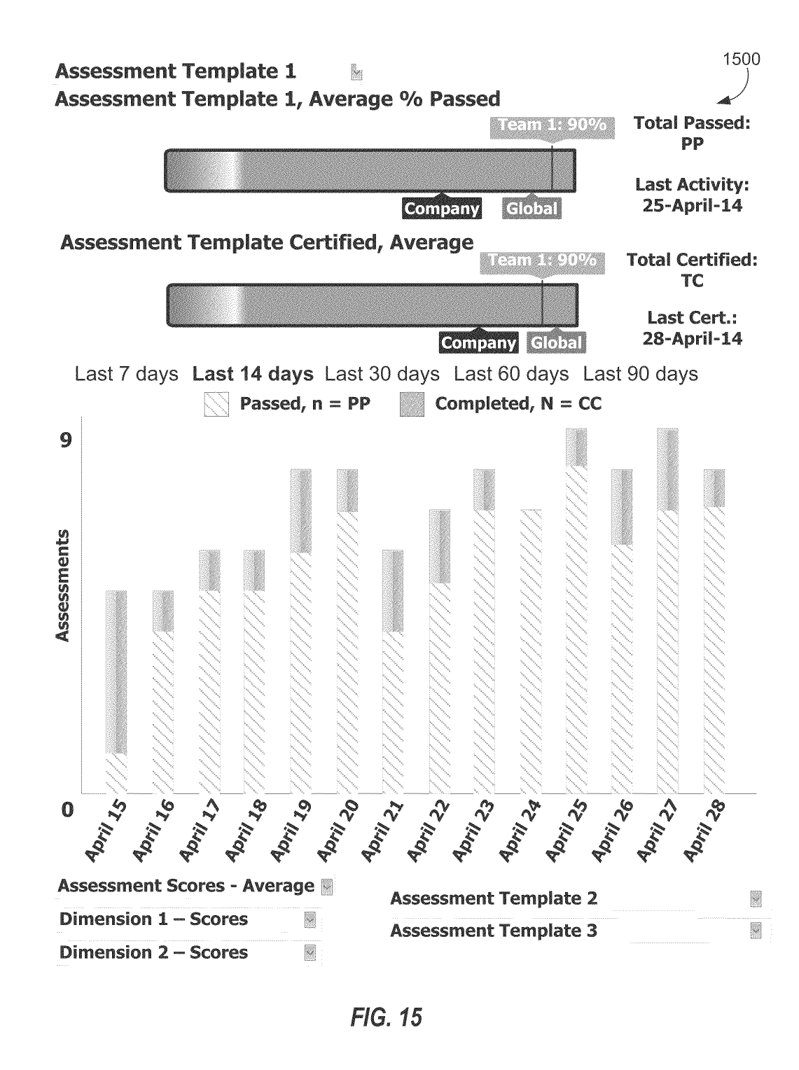

In some embodiments, aggregated summary results can be displayed on a tracking dashboard which may be available to individuals whose role has been specified to allow access to such data. As will be understood and appreciated, such tracking dashboards can take many forms and representation methods. For example, FIG. 15 shows the home view of a tracking dashboard 1500, according to one embodiment. In some embodiments, a dashboard may show the aggregated results for all service providers based on a single AT (e.g., “Assessment Template 1” as shown in FIG. 15). An example tracking dashboard may display performance data for the specific group of individuals (e.g., Team 1) relative to the rest of the company's staff groups (i.e., other teams in the organization). For example, in some embodiments, a system can determine and output for display a company-wide average based on a particular AT. Further, in some embodiments, a system can compare company results to results accumulated at other companies using the same AT to provide a global average against which the company can compare itself. Further, a system can compile and output, for display at the dashboard, information related to the number of completed assessments using a particular AT and the number of completed assessments that were determined to be “passing.” Further, in some embodiments, the dashboard may provide users access to specific data relating to a particular AT's dimensions or PAC, and the dashboard may facilitate the examination of data for other ATs.

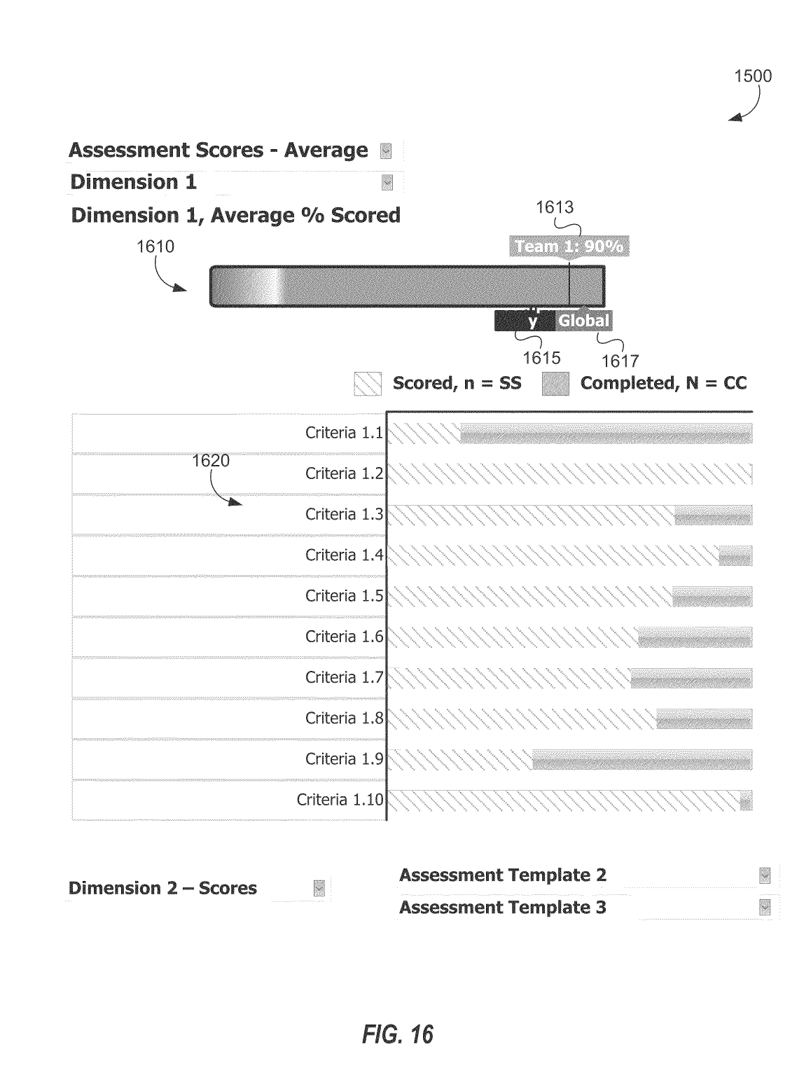

FIG. 16 shows an expanded view of one section of the example tracking dashboard 1500, according to some embodiments. In particular, FIG. 16 shows an expanded view of performance data 1610 specifically related to Dimension 1 of the AT, the average performance of Team 1 1613 relative to the company's average results for Dimension 1 of this particular AT 1615, and the broader global average for Dimension 1 of the particular AT 1617. Further, FIG. 16 shows one option for an embodiment of a display mechanism of the individual PAC specified for the dimension for the particular AT 1620, though the displayed option is not intended to be limiting.

As discussed, in some embodiments, a customer assessment template may comprise a list or group of individual Performance Assessment Criteria (PACs) that define the series of steps necessary for completing a task. Generally, each PAC in a customer assessment template can be used to assess a provider's completion of the task associated with the PAC. For example and not limitation, a customer assessment template may be entitled “Criteria for Hand Washing at the Bedside” and include one or more PACs related to the correct performance of this process. As will be understood and appreciated, such a customer assessment template would typically allow an evaluator to assess a provider's compliance with the PAC-defined steps for bedside hand washing.

Different customer assessment templates can exist for each of the individual service operator or provider roles involved in the completion of a particular task, activity, or process, or they may exist in a single template applicable to several service operator or provider roles, if appropriate. In other words, a particular task may require multiple operators to perform various tasks throughout the undertaking of the task, activity, or process. Different customer assessment templates can be created for each operator that participates in the activity so that the various operators can be evaluated based on their contribution to the activity. Similarly, team- or group-level PACs may be defined that apply equally to the different service operators and providers, or how they function as a team. In such cases, a single customer assessment template may exist for evaluating a team's collective performance of a particular task.

For example, FIGS. 6 and 7 show examples of PAC entry Graphical User Interface (GUI) screens 600 and 700 for an embodiment of the presently disclosed system. FIG. 6 is a GUI 600 for real-time completion of a 10-PAC AT that is single dimension and includes binary selection, according to some embodiments. In some embodiments, the single dimension in the 10-PAC AT GUI 600 shown in FIG. 6 could apply to an individual stakeholder's performance or could be used to evaluate a team's performance. FIG. 7 is a GUI 700 for real-time completion of a two-dimension, 10-PAC, 3-scale AT that can be used to evaluate a team's combined performance, according to some embodiments. As shown in FIG. 7, in some embodiments, a GUI 700 can provide definitions 710 to describe to an assessor how to utilize a 3-scale system based on the provided two dimensions. For example, in some embodiments, and as shown in FIG. 7, a first dimension can define various team criteria to be assessed, and a second dimension can define various task criteria to be assessed. Thus, in some embodiments, the basis for performance evaluation can shift an individual's specific competencies to the ability of the individual to function as part of a team.

### Evaluation Using Direct Questions

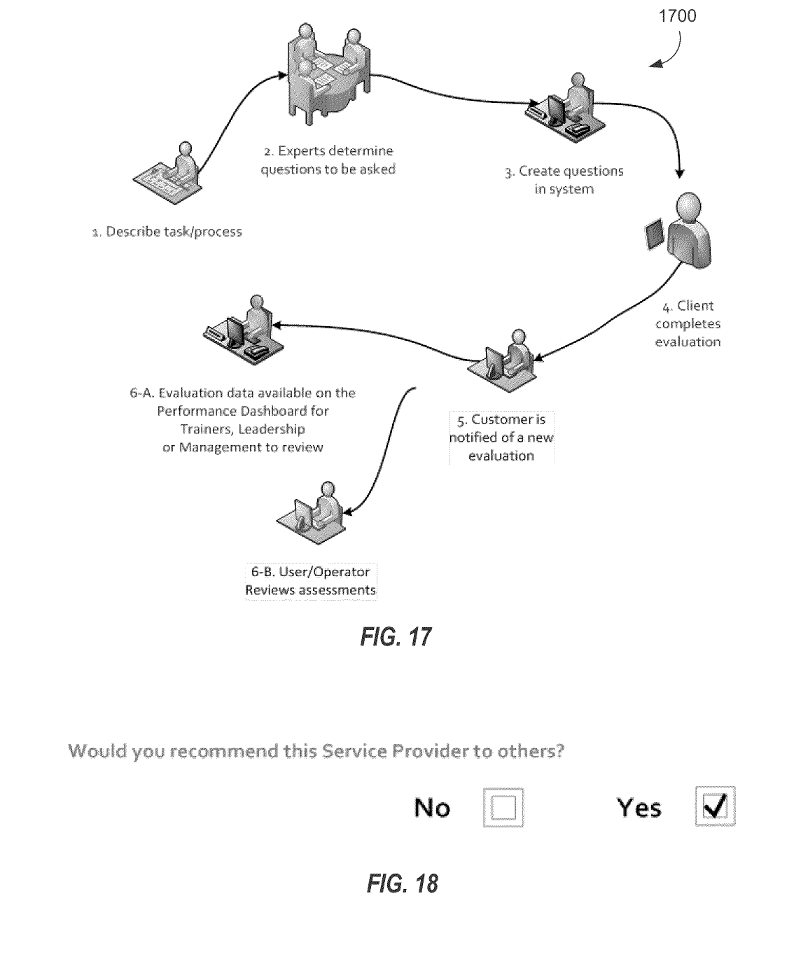

FIG. 17 is an example embodiment of a process 1700 for direct question evaluations. In some embodiments, the embodiments of the presently disclosed system can allow organizations to generate specific questions to be answered by certain assessors (e.g., customers). Further, in various embodiments, responses to an organization's question can take many forms including, for example, Yes/No with tick box or radio button-type inputs (see, e.g., FIG. 18), Likert Scales (see, e.g., FIG. 4), graphic rating scales (see, e.g., FIG. 5), and other suitable response inputs. Generally, embodiments of the disclosed technology allow organizations to select which input types and/or questions that will allow for anonymous submission to protect the assessor's identity and privacy. Further, embodiments of the disclosed technology can be configured to record the date and time at which the assessment begins. Additionally, in some embodiments, the system can be configured to provide to an assessor (e.g., a customer) the opportunity to select which registered service operator, provider, group, or team is to be assessed, and, subsequent to receipt of the assessor's selection, allows the assessor to complete the relevant questions.

### Evaluation Using Descriptive Text

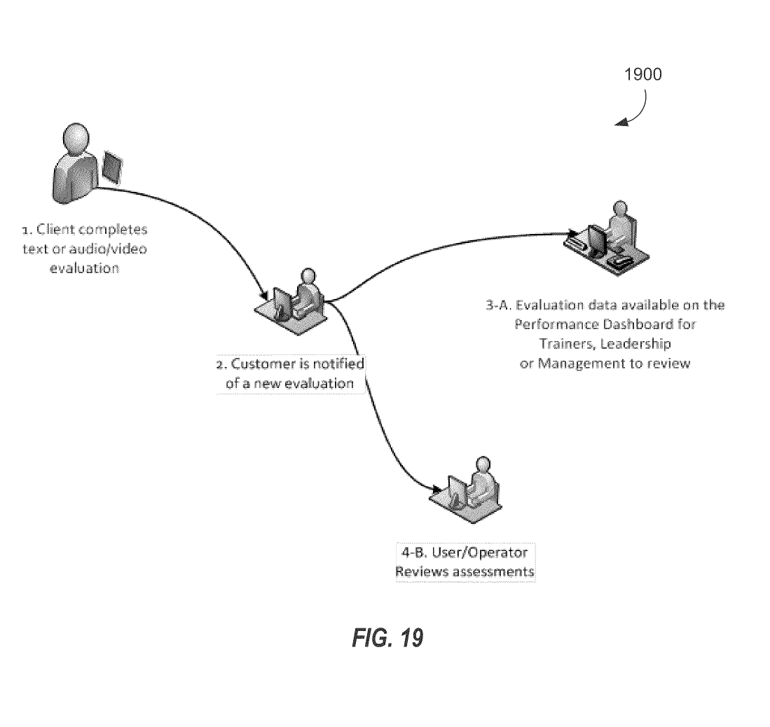

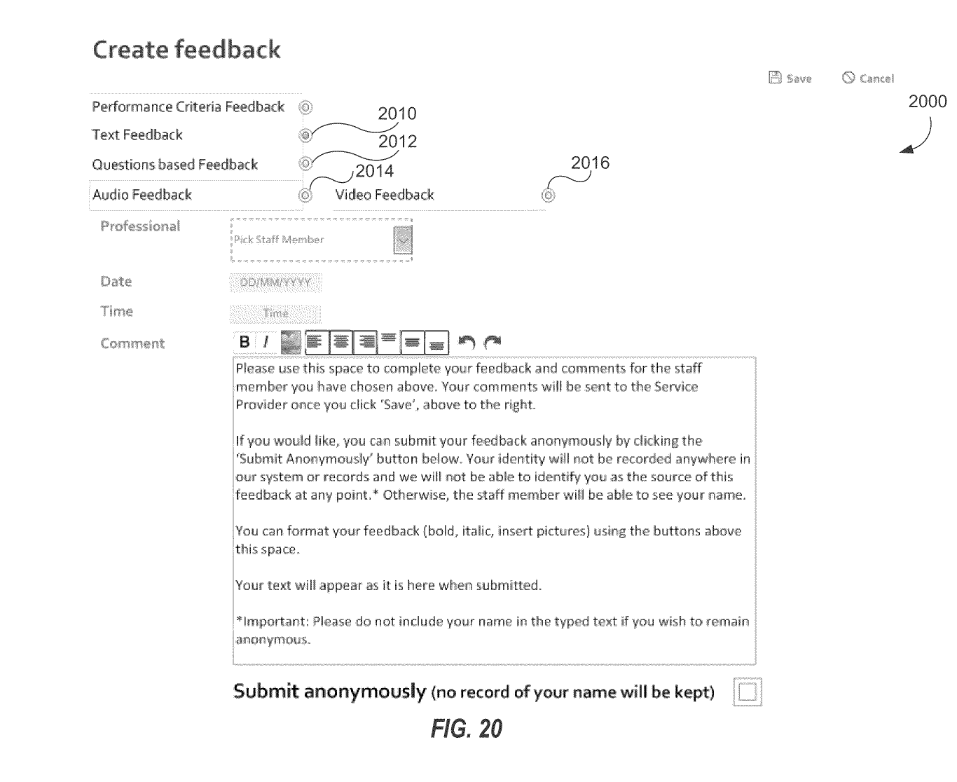

FIG. 19 is a representation of an example process 1900 for evaluations via descriptive text or audio/video feedback. In some embodiments, the presently disclosed system allows an assessor (e.g., a customer) to select the service operator or provider they would like to assess, automatically records the date and time the assessment was started, and enables the customer to freely enter text with rich text formatting options (e.g., bold, italic, underline, bullets, and other options). FIG. 20 is an example embodiment of an input terminal 2000 at which a user can provide descriptive text feedback. As shown in FIG. 20, in some embodiments, a system may provide to an assessor options for providing feedback. Accordingly, for example and not limitation, a system may provide selectable radio buttons for providing text feedback 2010, question-based feedback 2012, audio feedback 2014, and video feedback 2016. As will be appreciated, the assessor is able to submit the descriptive text evaluation anonymously to protect the assessor's privacy. Further, in some embodiments, a system may allow an assessor to see a preview of how their text will appear once submitted, as they type, or once completed but prior to a final submission. In some embodiments, a system can provide a warning message to alert an assessor that submitted evaluations and feedback cannot be retracted, removed, or edited. Alternatively, in some embodiments, a system can allow an assessor to retract, remove, or edit a submission. The warning message could also inform an assessor that by submitting the descriptive text feedback, the assessor is consenting to its use by the organization, and the message could further include consent and permission to share or make public the submission if chosen by the service operator or provider. Such materials could be used for advertising or marketing campaigns by the organization.

### Evaluations Using Audio/Video Feedback

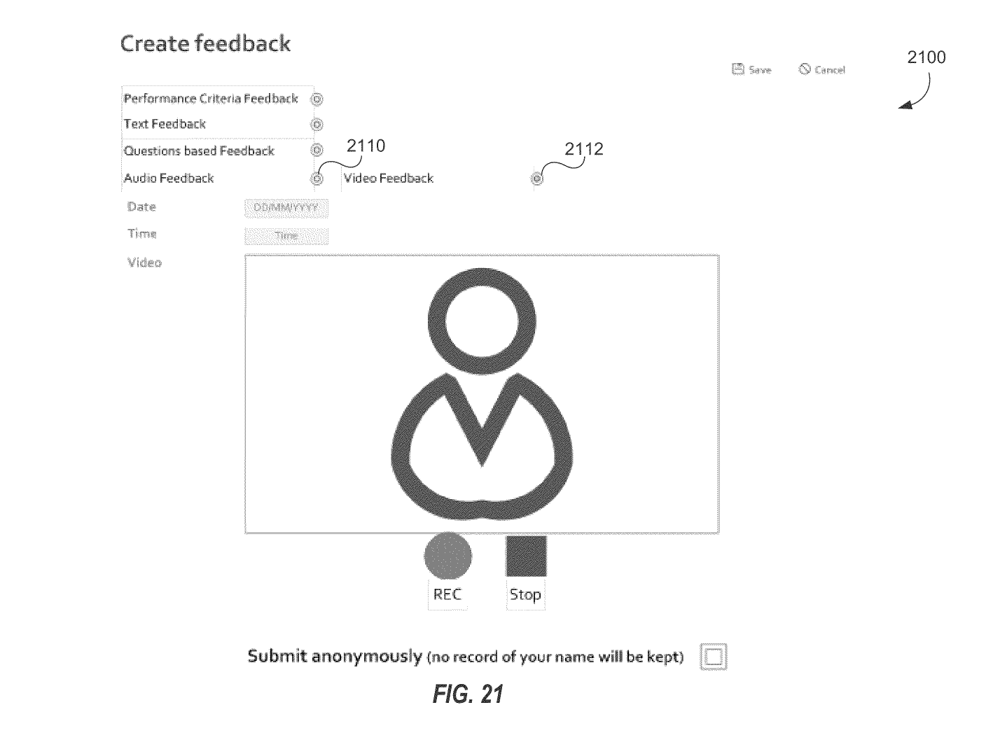

As noted, FIG. 19 is an example representation of a process 1900 for evaluations via descriptive text or audio/video feedback. Accordingly, in some embodiments, assessors may complete evaluations and assessments in real-time via audio or video recording. FIG. 21 is an example GUI 2100 for audio/video evaluations. In some embodiments, the system can record the date and time at which the assessment begins. According to some embodiments, the assessor can select which registered service provider is to be assessed. Typically, the assessor can select to record an audio track 2110 or to upload video 2112 that can be uploaded to a private section on the service operator or provider's profile. In some embodiments, the audio/video can then be reviewed by the service operator or provider and/or by trainers or leadership. The service operator or provider may or may not choose to share the videos with their peers (i.e., other service providers or operators, their trainers, managers, or leadership).

Generally, the system can allow assessors to submit audio recordings anonymously; in some embodiments, however, video recordings can only be submitted with the assessor's registration name included. In some embodiments, saving either audio or video recordings triggers a notification to the assessor that by submitting the recording they are consenting to its use by the organization and includes consent and permission to share or make public the recording if chosen by the service operator or provider. As previously noted, such materials could be used for advertising or marketing campaigns by the organization.

### System Gamification

In certain embodiments, it is possible that aspects of the disclosed system can be gamified to encourage user engagement. For example, service operators or providers could automatically gain points based on evaluations and scores that reflect their competency as it relates to a particular task. In some embodiments, an accumulation of points by a service operator based on PAC responses (e.g., PACs achieved or correctly demonstrated) could signify the service operator or provider's competency and could further be used for certification purposes (i.e., to certify the service operator or provider) or could result in additional benefits, incentives, or rewards for the service operator or provider (e.g., financial bonuses or professional recognition within the organization).

Alternatively, in some embodiments, trainers, managers, or leadership may award additional system points to service operators or providers on a case-by-case basis based on descriptive text or audio/video evaluations that relate to a service operator or provider's performance (i.e., the points can be awarded manually). The manual awarding of system points could provide a methodology for organizations to track and reward service providers for real-world activities in a virtual environment. As will be appreciated, the ability for trainers, managers, or leadership to add, to a service operator or provider's system profile, an acknowledgement, certification, or record of competence or performance for activities performed in the real-world supports the gamification of real-world activities and integrates them into the virtual-world of the disclosed system. As will be further appreciated, this ability can enable trainers, managers, or leadership to support the creation of a detailed professional profile of each service operator or provider's certified competency in addition to the skills the service operator or provider has acquired and demonstrated beyond those specified by each organization's Assessment Templates. Put differently, service operators and providers can achieve credit for going beyond existing organizational requirements, which can result in the creation of new professional norms and expectancies within the organization, thus supporting a process of continuous improvement and organizational evolution centred around organizational competence, excellence and quality of service delivery.

As will be understood and appreciated, such functionality could encourage service operators or providers to share their evaluations within the system for review by their colleagues, which can enhance peer learning.

### Example System

### Evaluation of ‘Hand Hygiene’

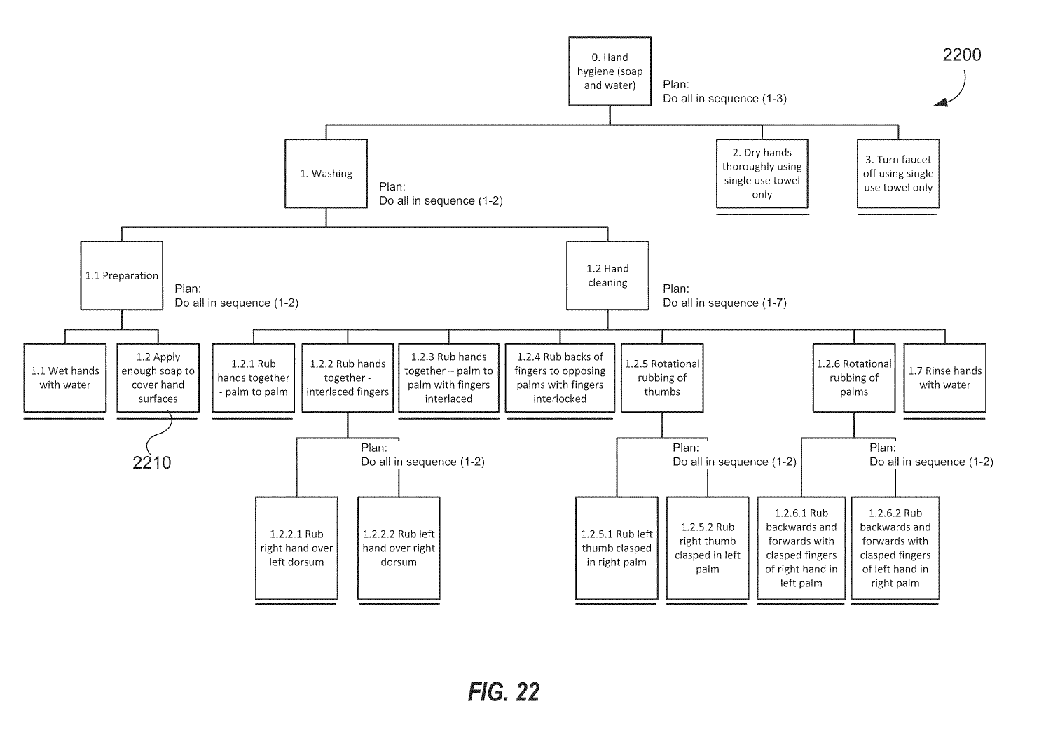

As noted, FIG. 3 shows a representation of an assessment process 300, according to some embodiments. In a real-world setting, the task, activity, or process may be described graphically. For example, Hierarchical Task Analysis (HTA) can be used to describe a particular task. FIG. 22 is an example HTA 2200 for hand hygiene using soap and water, according to some embodiments. Thus, in some embodiments, a process (e.g., the process for properly cleaning one's hands with soap and water) can be analyzed to determine the criteria necessary for completing the task. As will be understood and appreciated, however, it may not be practical to evaluate someone's performance of a task using each criterion identified in an HTA (e.g., HTA 2200). Thus, when creating a PAC relating to hand washing, an administrator can select from all of the steps shown in HTA 2200 or a subset of the steps as deemed appropriate. For example, in some embodiments, using the HTA 2200 shown in FIG. 22, an administrator can identify certain high performance criteria related to hand washing, which could include, certain subtasks such as subtask 1.2 (i.e., “Apply enough soap to cover hand surfaces”) 2210. Thus, in some embodiments, a PAC for hand washing could include the binary step of “Operator used sufficient quantity of soap.”

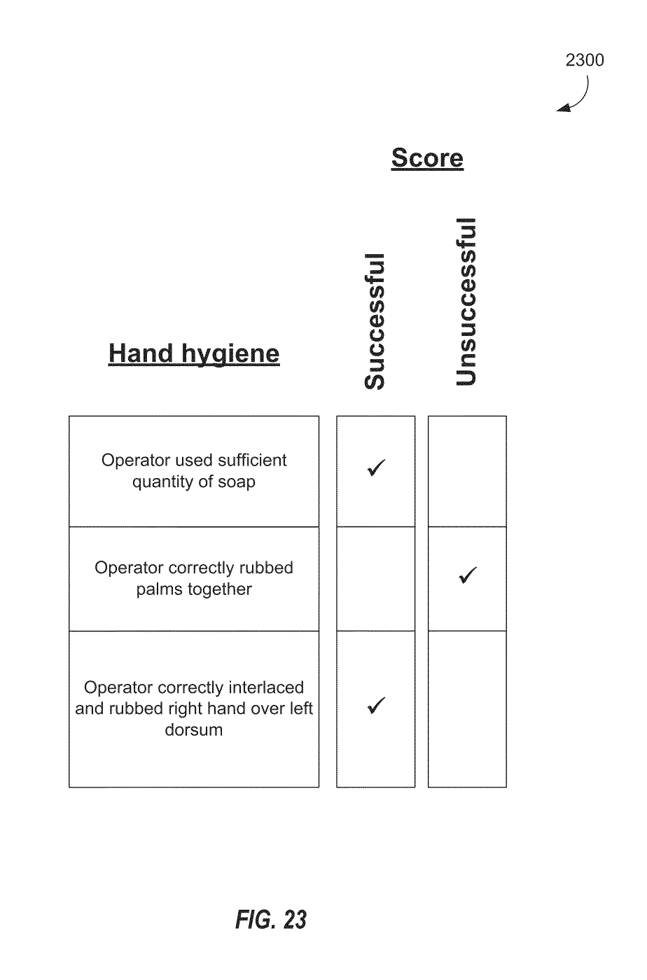

As noted, in some embodiments, the criteria shown in the HTA 2200 can form the basis of a PAC which can be incorporated into an associated AT (i.e., an AT for hand washing), which could appear similar to the example AT 2300 shown in FIG. 23. Accordingly, in some embodiments, an assessor could observe the hand hygiene process for one or more trainees or experienced staff members to assess their performance and then complete the assessment by selecting the appropriate option for each step of the PAC using a computing device (e.g., a tablet computer). Completed assessment data can be stored in a database associated with the computing device for later retrieval and review as required by the assessor, operator, leadership, managers, or trainers.

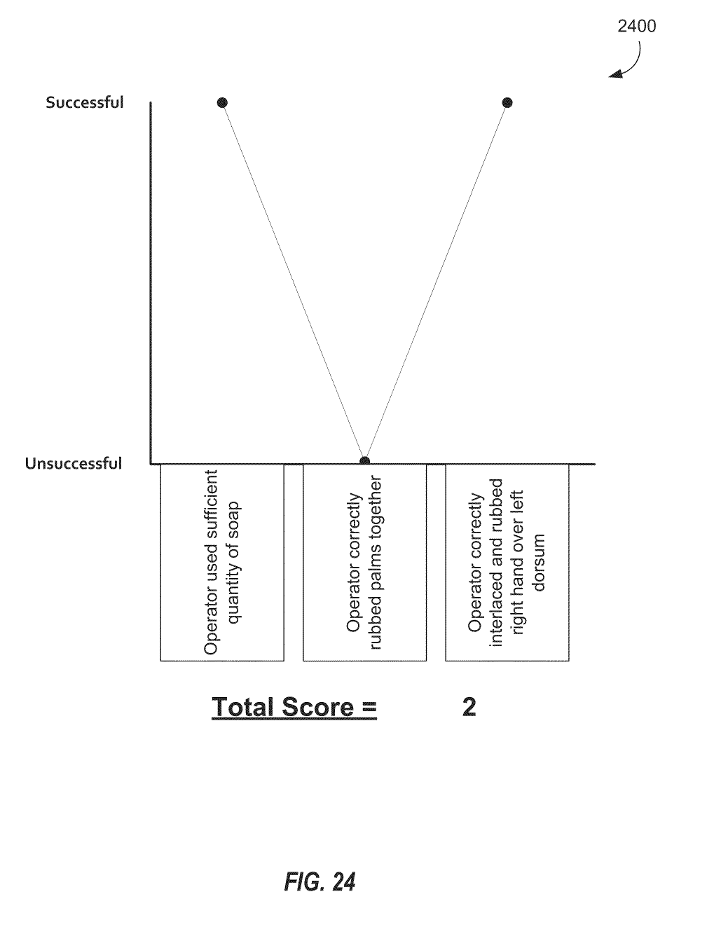

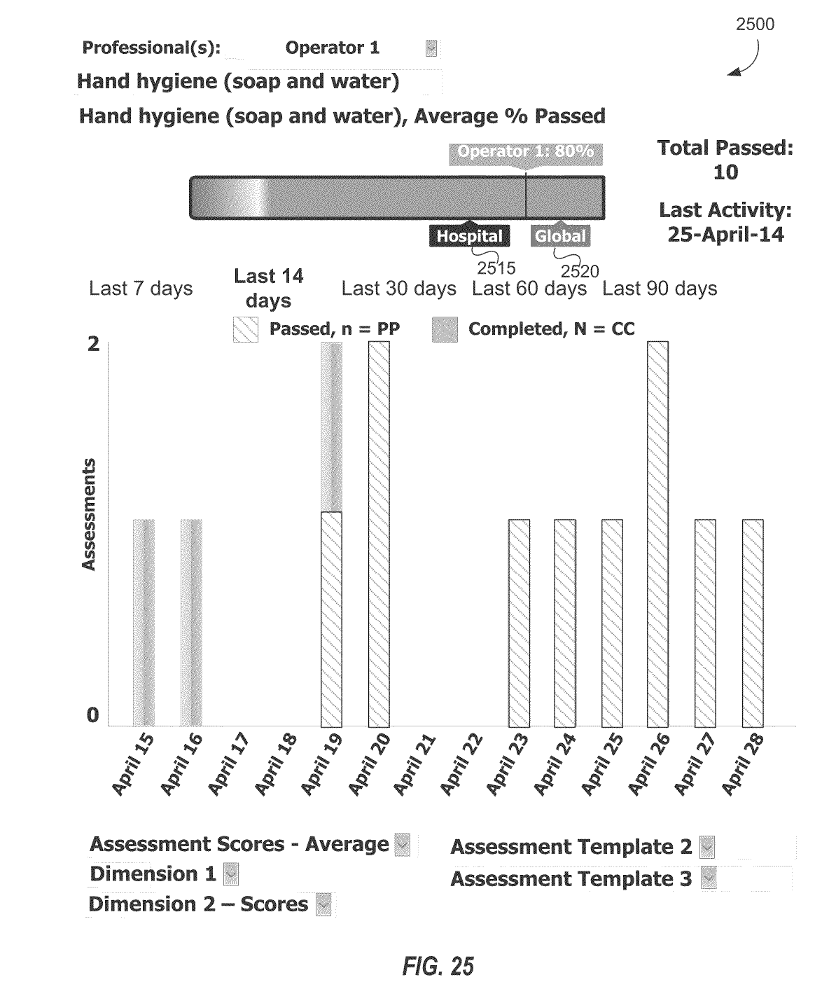

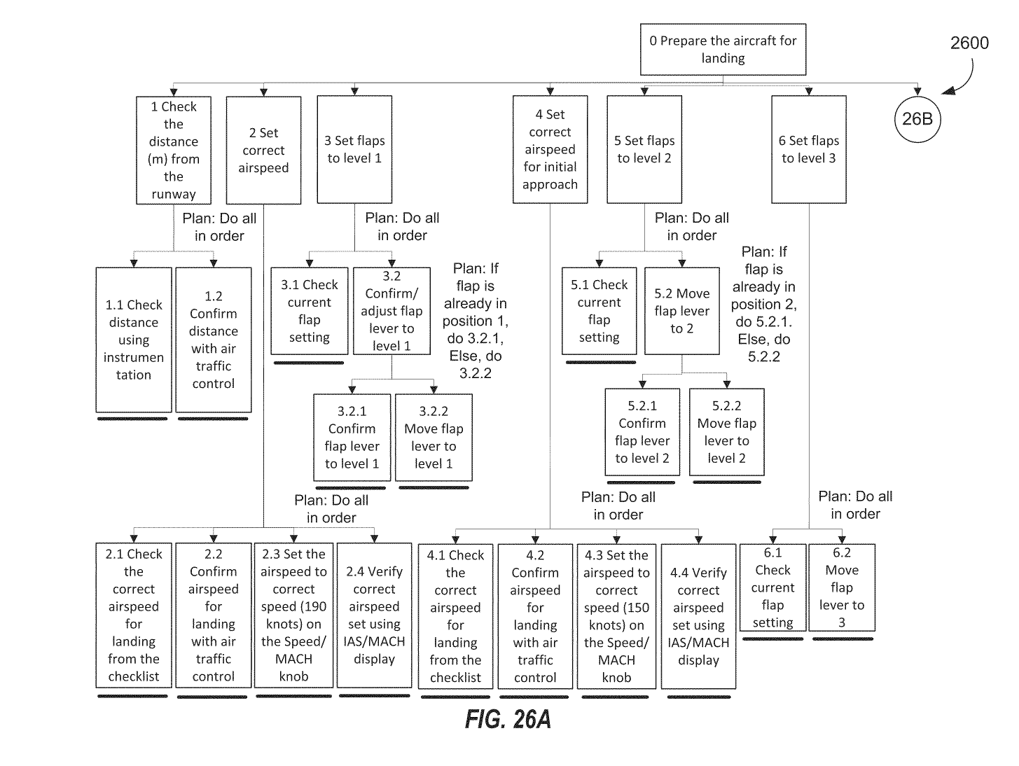

FIG. 24 is a graphical display 2400 of example results of an assessment conducted using the single-dimension PAC embodied by AT 2300. As shown, the service provider was assessed as having successfully completing two of the three criteria in the hand washing PAC. FIG. 25 further shows summarized results of an assessment conducted using the single-dimension PAC embodied by AT 2300 on a tracking dashboard 2500, according to some embodiments. As shown on the tracking dashboard 2500, results for an individual can be shown relative to peers in a local environment (e.g., hospital 2515) or, if working in a larger environment (e.g., a multinational organization or community), relative to the entire network (e.g., global 2520). As will be appreciated, such an information display supports assessors, managers, leadership, and trainers in understanding the competency and proficiency levels of employment operators, which may help ensure that the necessary skills mix is available within the team, group, or organization.

### Evaluation of ‘Pilot Preparing an Aircraft for Landing’

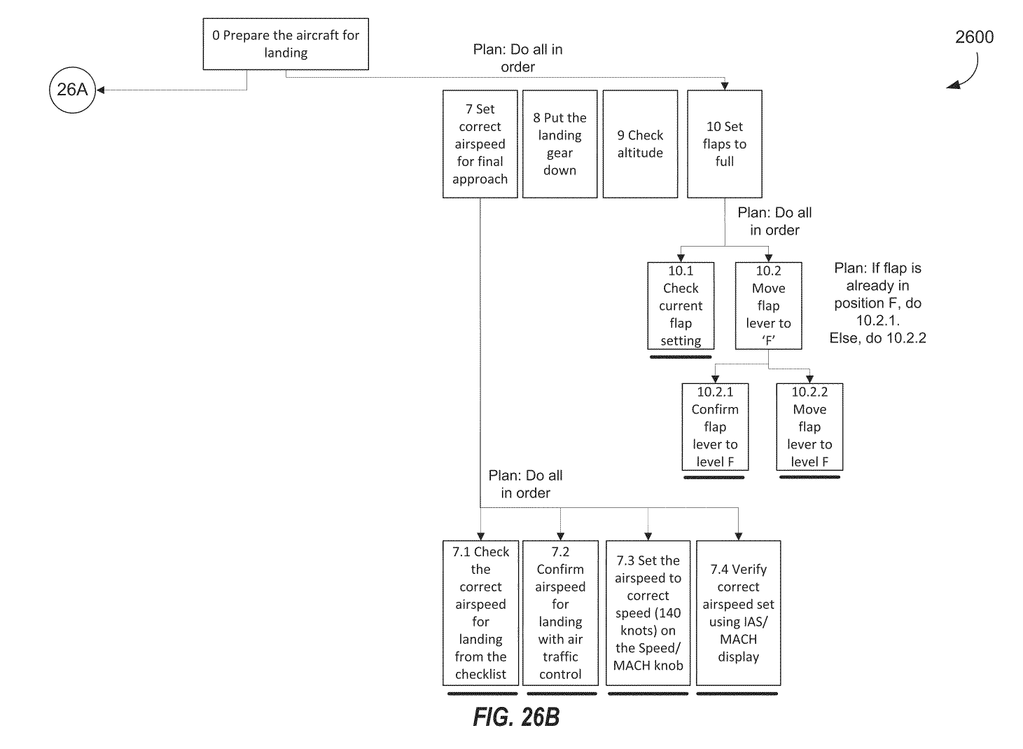

FIGS. 26A and 26B are an example HTA 2600 for the process of ‘Preparing an Aircraft for Landing,’ according to some embodiments. As shown in the HTA 2600, preparing an aircraft for landing can comprise ten primary tasks, some of which have multiple subtasks. In reviewing the HTA 2600, it can be determined that there are two analysis dimensions relevant to the tasks and sub-tasks: (i) Action/Checking criteria; (ii) Communication criteria. Table 1 shows various high-performance criteria necessary for preparing an aircraft for landing that are broken out by dimension (i.e., whether they are Action/Checking criteria or Communication criteria).

TABLE 1

| Physical/Checking Criteria | Communication Criteria |
|---|---|
| 1 Correctly check distance using | 2 Confirm distance from runway with ATC |
| instrumentation | |
| 4 Correctly checked the airspeed for landing | 3 Used appropriate tone of voice and clarity |
| using checklist | of speech with ATC when confirming |
| | distance |
| 7 Airspeed correctly set to 190 knots | 5 Confirm airspeed for landing with ATC |
| without over-adjustment | |
| 9 Check flap setting | 6 Used appropriate tone of voice and clarity |
| | of speech with ATC when confirming |
| | airspeed |
| 11 Flap setting correctly set to/confirmed at | 8 Verified airspeed 190 knots using |
| level 1 | instrumentation |
| 12 Correctly checked airspeed for initial | 10 ‘Speak aloud’ current flap setting |
| approach using checklist | |
| 15 Airspeed correctly set to 150 knots | 13 Confirmed airspeed for landing with |
| without over-adjustment | ATC |
| 17 Check flap setting | 14 Used appropriate tone of voice and |
| | clarity of speech with ATC when |
| | confirming airspeed for initial approach |
| 19 Flap setting correctly set to/confirmed at | 16 Verified correct airspeed of 150 after |
| level 2 | instrumentation review - ‘speak aloud’ |
| 20 Correctly checked flap setting | 18 ‘Speak aloud’ current flap setting |
| 22 Flap setting correctly set to/confirmed at | 21 ‘Speak aloud’ current flap setting |
| level 3 | |
| 23 Correctly checked airspeed for final | 24 Confirmed airspeed for landing with |
| approach using instrumentation | ATC |
| 26 Airspeed correctly set to 140 knots | 25 Used appropriate tone of voice and |
| without over-adjustment | clarity of speech with ATC when |
| | confirming airspeed for final approach |
| 28 Correctly put the landing gear down | 27 Verified correct airspeed of 140 after |
| | instrumentation review - ‘speak aloud’ |
| 30 Correctly checked altitude | 29 ‘Speak aloud’ landing gear down |
| 32 Correctly checked flap setting | 31 ‘Speak aloud’ current altitude |
| 33 Flap setting correctly set to/confirmed at | 34 ‘Speak aloud’ current flap setting |
| level ‘F’ | |

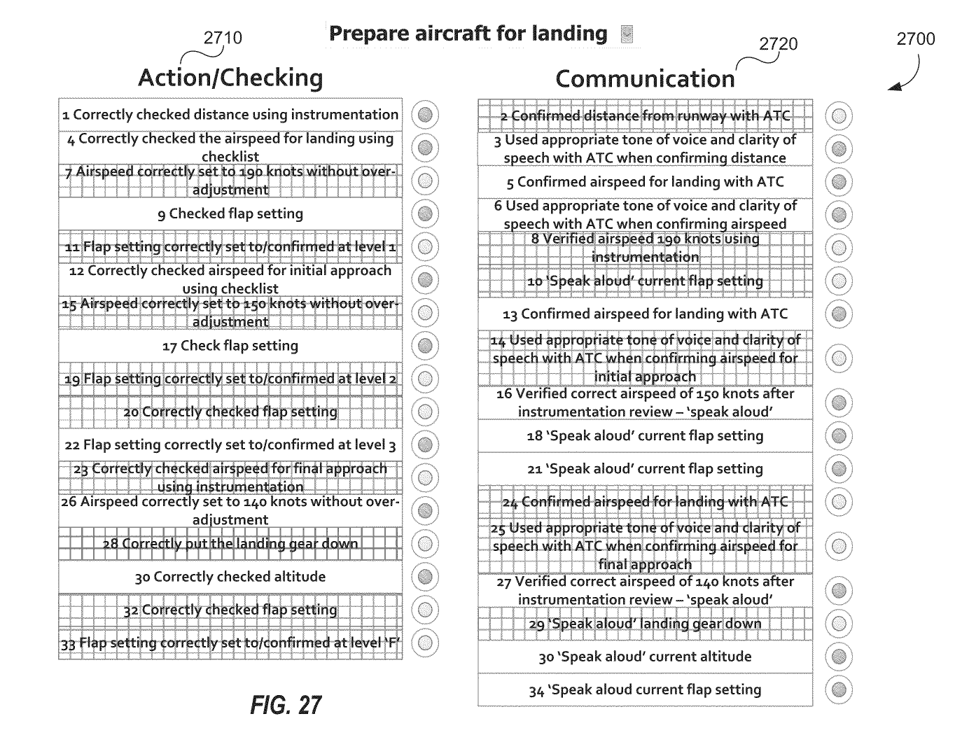

As will be understood, using the two dimensions and the requirements of the tasks and sub-tasks shown in HTA 2600, it is possible to determine the high-performance criteria as shown in Table 1. Further, as will be understood, a manager or anyone else tabbed to create an appropriate AT relating to preparing an aircraft for landing, can convert the proposed example dimensions and high-performance criteria from Table 1 into a an assessment template 2700 as shown in FIG. 27, according to some embodiments. As shown in FIG. 27, the assessment template 2700 comprises separate columns 2710 and 2720 relating to the two dimensions discussed above (i.e., Action/Checking and Communications), respectively. As shown in FIG. 27, in some embodiments, PACs that have been successfully completed can be displayed in a manner that distinguishes them from PACs that have not been successfully completed. For example, as shown in FIG. 27, successful PACs are shown with no hatching, and unsuccessful PACs are shown in cross-hatching.

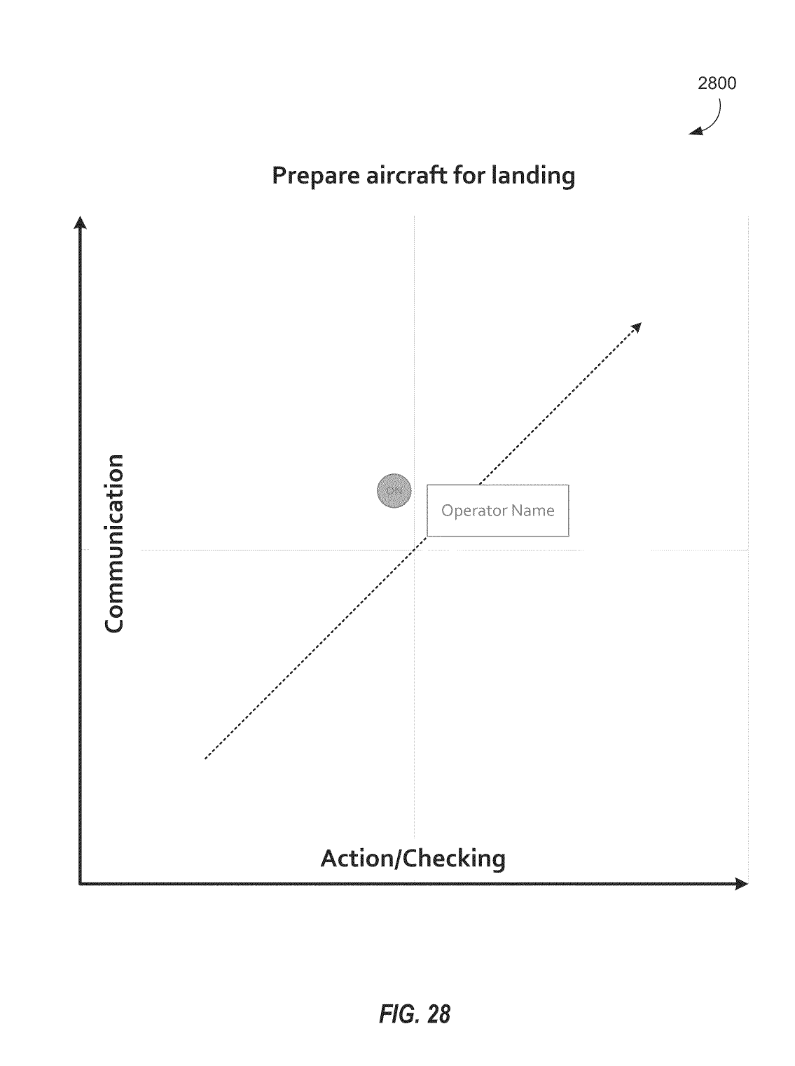

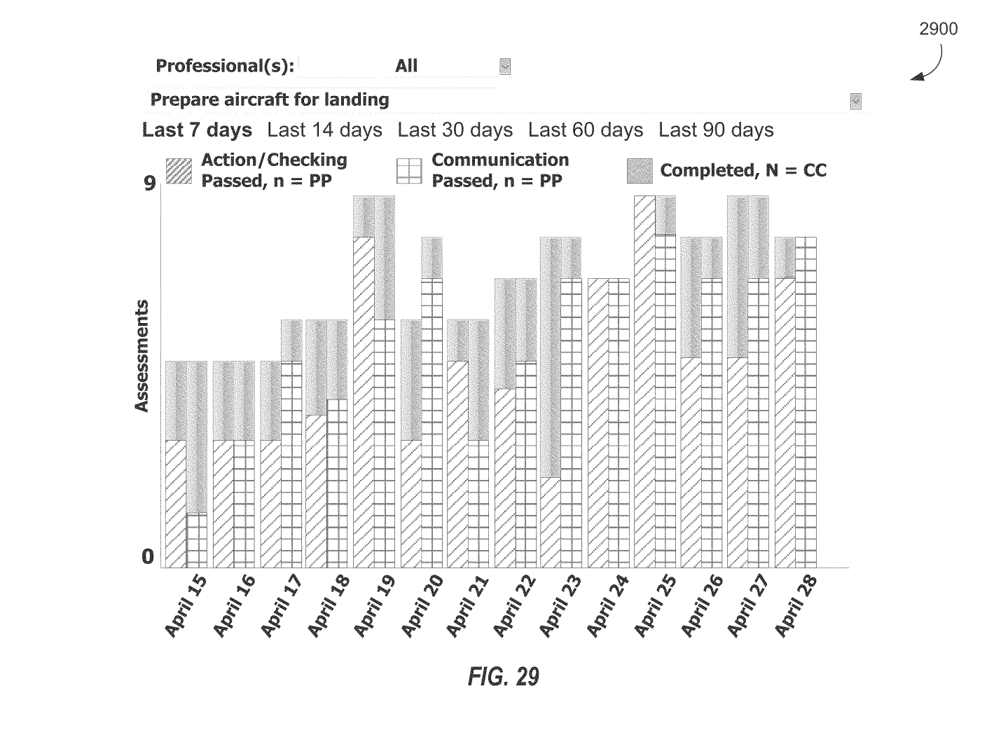

Further, FIG. 28 shows an embodiment of an example results page 2800 based on the results inputted to the assessment template 2700, according to some embodiments. In some embodiments, a plot marker, denoted in FIG. 28 as “Operator Name,” can indicate the PAC attained by the service operator or provider as evaluated by the assessor. As will be understood and appreciated, the location of the plot marker can represent the number of PACs observed by the assessor for each of the two dimensions (i.e., “Action/Checking” and “Communication”). Further, in some embodiments, a results page 2800 can display which specific PACs were observed by an assessor as being successfully completed to produce the shown results and which PACs were not observed as being successfully completed. For example, as was shown in FIG. 27, criteria shown with a clear background can indicate the criteria were observed as having been successfully completed while those with square hatching were unsuccessful. Further, FIG. 29 shows an exemplary dashboard 2900 associated with the task of preparing a plan for landing, which according to the foregoing example, has two dimensions. As shown in the dashboard 2900, for each assessment, the results of the two dimensions can be shown side by side.

### Evaluation of ‘Preparing Equipments for a Shallow Scuba Dive’

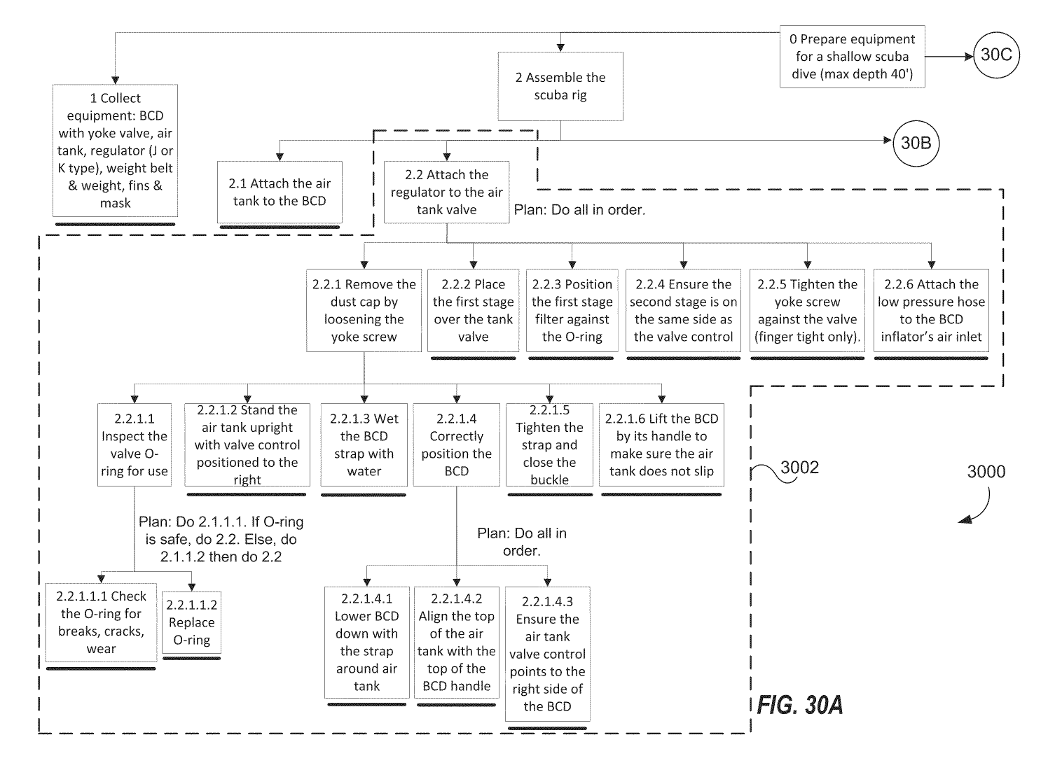

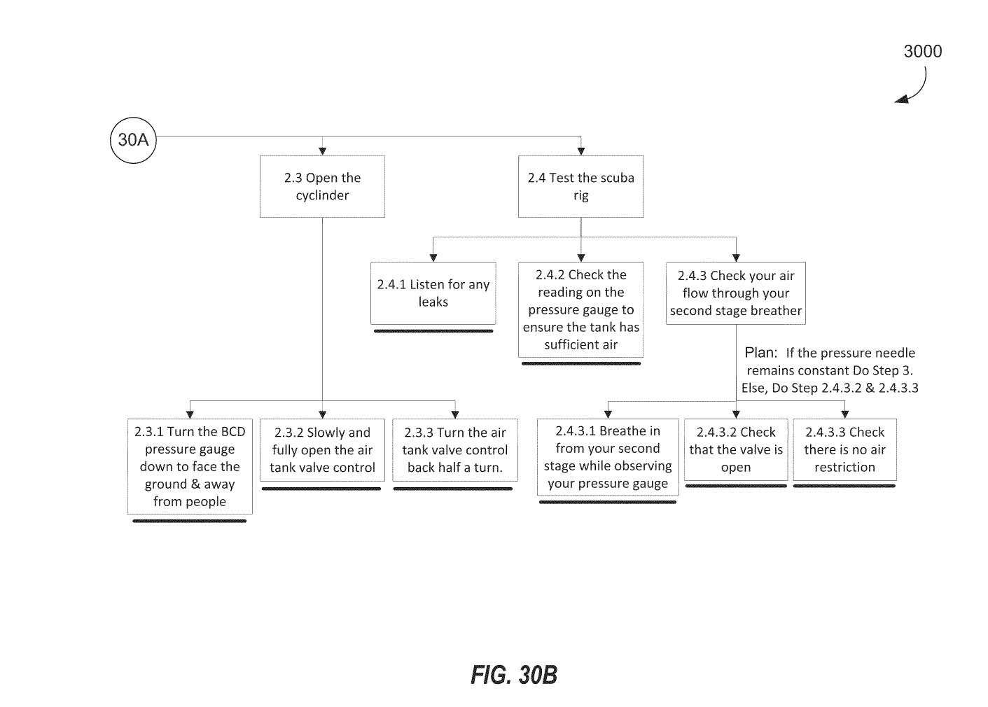

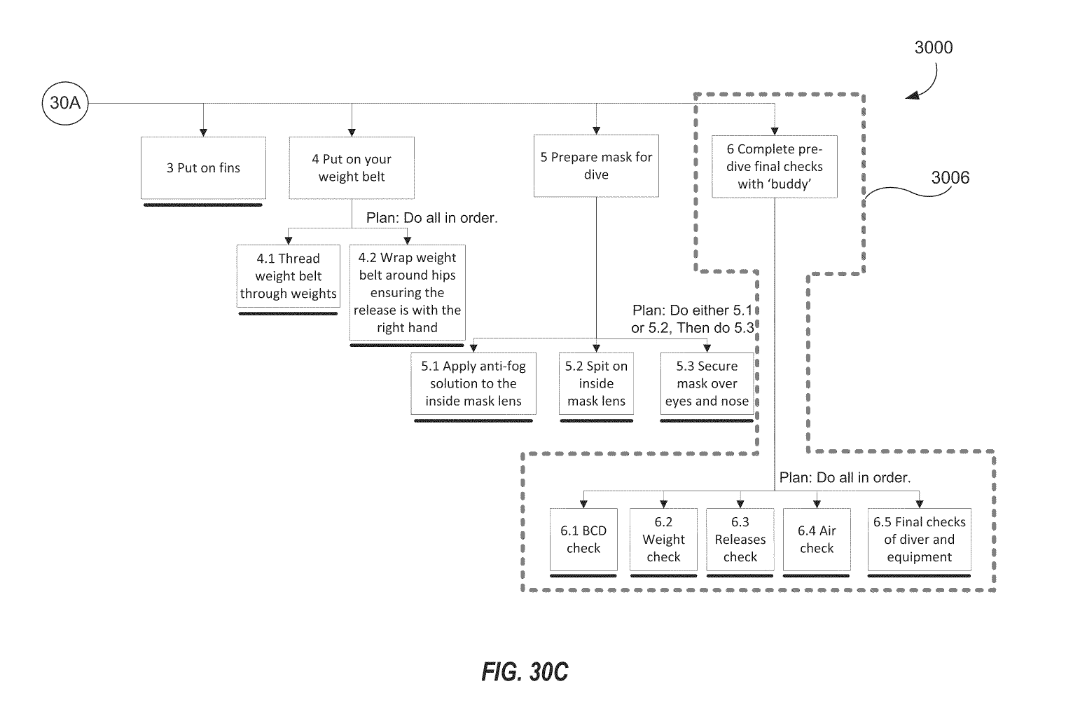

FIGS. 30A-30C are an example HTA 3000 for the process of ‘Preparing Equipment for a Shallow Scuba Dive (max depth 40 feet),’ according to some embodiments. As shown in HTA 3000, preparing equipment for a shallow scuba dive can comprise six primary tasks, some of which have multiple subtasks. For example, focusing on subtask 3006, ‘Complete Pre-Dive Final Checks,’ it can be noted that there are two analysis dimensions relevant to the tasks and sub-tasks associated with subtask 3006: (i) Skills—Checking criteria; (ii) Attitudes—Communication criteria. Table 2 shows various high-performance criteria necessary for subtask 3006:

TABLE 2

| Skills - Checking Criteria | Attitude - Communication Criteria |
|---|---|
| 1 Checked ‘buddy’ BCD inflates from air | 2 Confirms BCD inflation |
| tank | |
| 3 Checked ‘buddy’ can manually inflate | 4 Confirms BCD manual inflation |
| BCD | |
| 5 Checked BCD remains inflated | 6 Confirms BCD remains inflated |
| 7 Checked ‘buddy’ can deflate BCD | 8 Confirms BCD deflation |
| 9 Checked weight belt ‘right hand’ release | 10 Confirms weight belt release is correct |
| 11 Checked weights are correctly positioned | 12 Confirms weights are correctly |
| | positioned |
| 13 Checked all releases are closed and | 14 Confirms releases are correct |
| positioned correctly | |
| 15 Checked smell of second stage air flow | 17 Confirms second stage air flowing |
| 16 Checked ‘buddy’ second stage air | 19 Confirms backup second stage air |
| flowing | flowing |
| 18 Checked ‘buddy’ backup second stage | 21 Confirms fins secure |
| air flowing | |
| 20 Checked fins secure | 23 Confirms mask is ready |
| 22 Checked mask is ready | 24 Confirms ‘buddy’ is ready to dive |

As will be appreciated, this example subtask 3006 focuses on a process that typically is completed in a recreational setting rather than a professional environment, but the criticality of the entire process 3000 being done correctly warrants its analysis not only during diver certification training but also as refresher training.

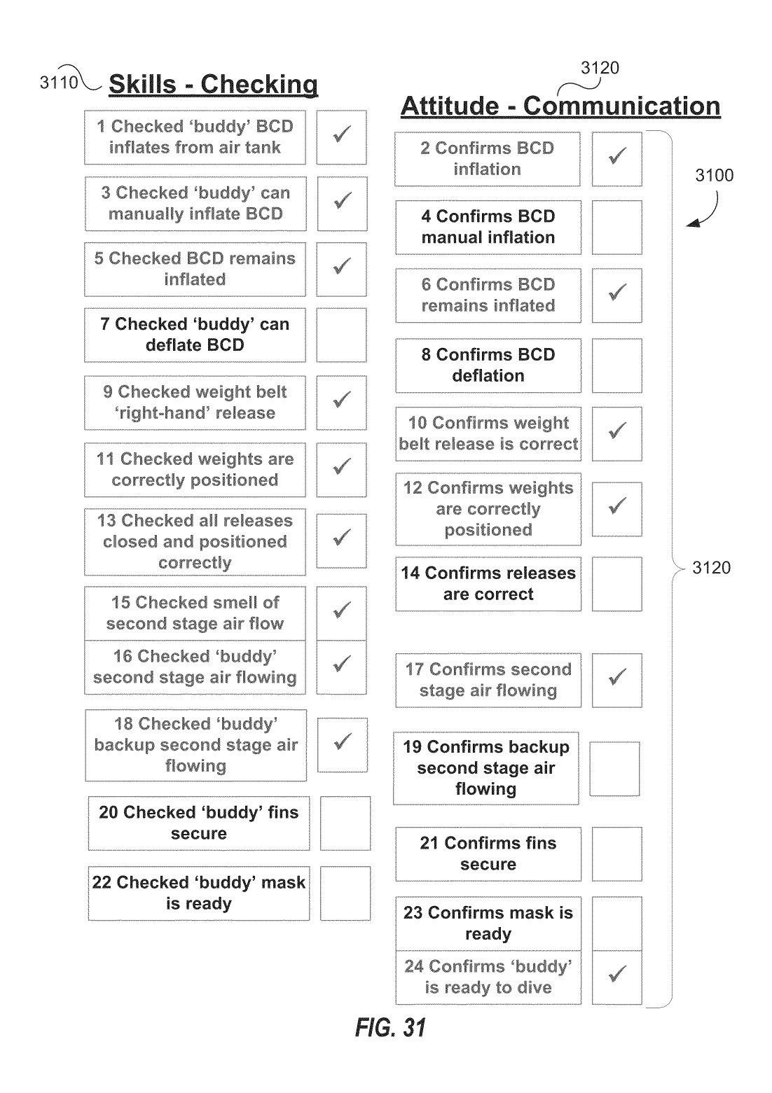

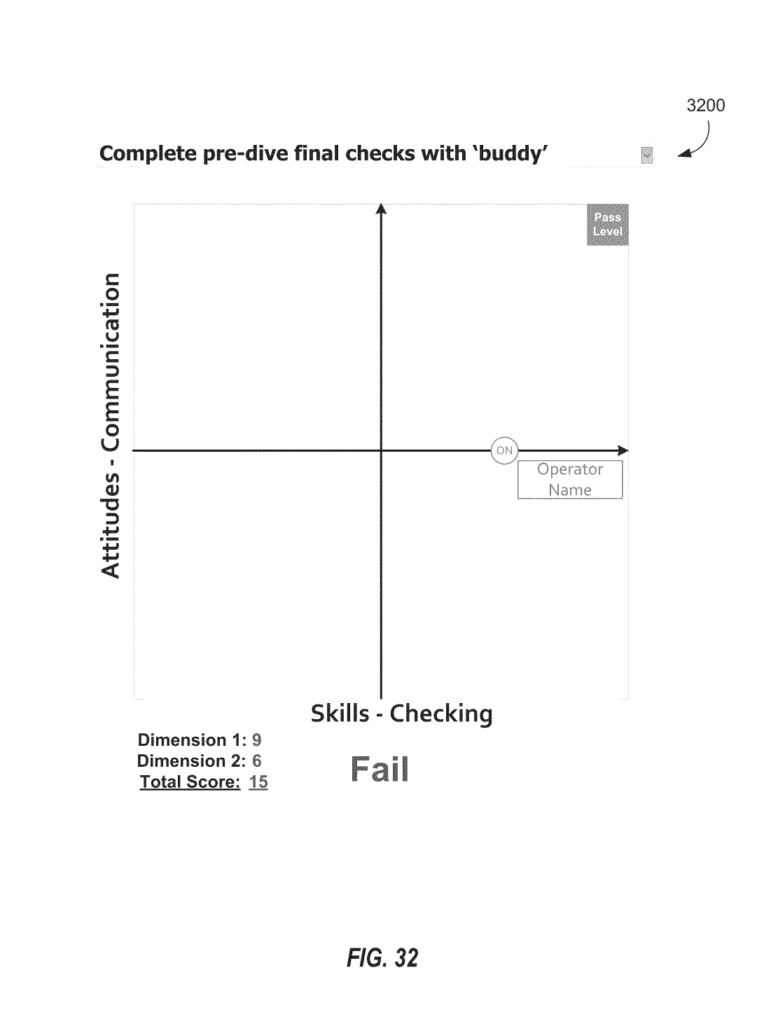

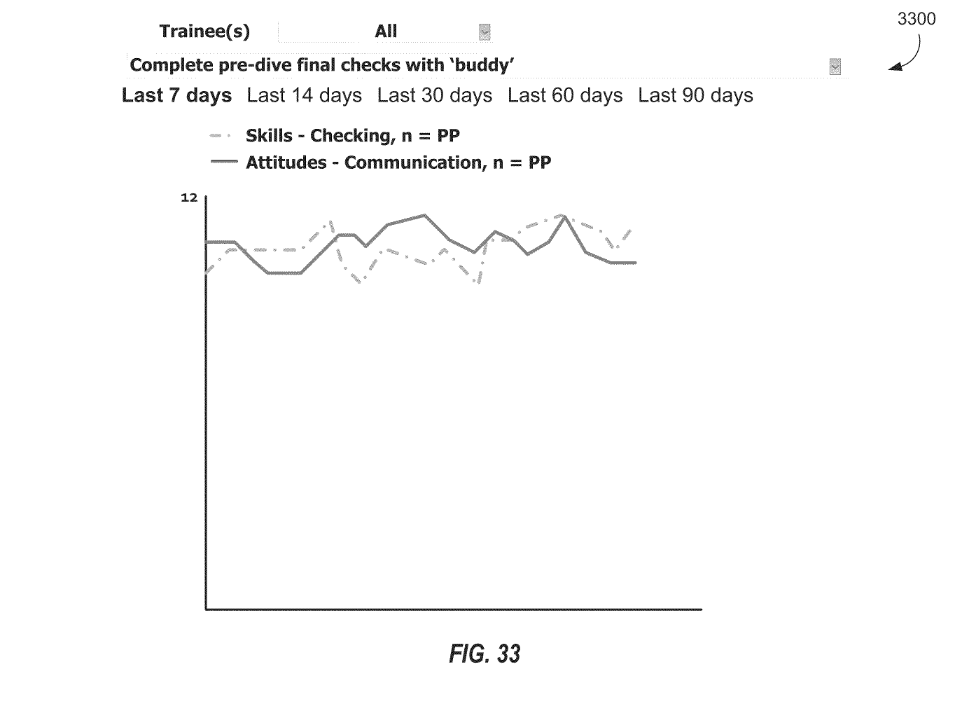

As will be understood, using the two dimensions and the requirements and the tasks and subtasks of subtask 3006, it is possible to create a PAC that can be embodied in an assessment template 3100 as shown in FIG. 31, according to some embodiments. Similar to assessment template 2700, assessment template 3100 comprises two columns 3110 and 3115, which correspond to the Skills/Checking tasks and the Attitude/Communication tasks, respectively. As shown in FIG. 31, the selection buttons 3120 associated with the various tasks can be staggered from one another to note to the assessor the order in which the tasks are intended to occur while keeping the dimensions of the criteria differentiated. FIG. 32 shows an example outputted results screen 3200 generated in response to the results inputted into assessment template 3100, according to some embodiments. Further, according to some embodiments, FIG. 33 shows an example tracking dashboard 3300 for the task of ‘Complete Pre-Dive Final Checks with Buddy” from HTA 3000. As shown in the dashboard 3300, in some embodiments, the results of the two dimensions can be overlaid on the same plot. The plot can show the variation in total dimension 1 and dimension 2 PAC observed by the assessor during the completion of subtask 3006 as recorded in assessment template 3100 over, for example, the past seven days. In some embodiments, the dimensions on a plot such as the plot in FIG. 33 can be hidden by the user to provide additional clarity.

### Evaluation of Scuba Dive Training—Prepare Scuba Rig for Shallow Dive

Subtask 3002 of FIG. 30A focuses on “attaching the regulator to the air tank valve,” according to some embodiments. As shown in FIG. 30A, this process 3002 outlines the tasks to be completed by a scuba dive operator (e.g., a trainer) to teach a scuba dive customer (i.e., a trainee) how to prepare their scuba rig. According to some embodiments, the process 3002 can comprise six main tasks, with certain of the main tasks comprising sub-tasks. As discussed herein, in some embodiments, the HTA 3000, and process 3002, can be used to generate PAC for the trainee to evaluate the trainer's performance and to provide feedback to the trainer regarding the delivery of their training. This activity of evaluating the trainer's performance could be completed as part of the service delivery itself or as part of the trainer's certification. Table 3 shows various assessment criteria relating to sub-task 3002 of HTA 3000, “Teach trainee how to attach the regulator to the air tank valve,”:

TABLE 3

| Task completed | Training Quality |
|---|---|
| 1) Show trainee how to attach the air tank to | 2) Task clearly explained and not rushed |
| the BCD | |
| 3) How to check the O-ring for breaks, | 4) Potential O-ring failures explained |
| cracks, wear | |
| 5) How to replace O-ring | 6) O-ring replacement was demonstrated |
| 7) Teach trainee to stand the air tank upright | 8) Stand position was clearly explained and |
| with valve control positioned to the right | demonstrated |
| 9) Teach trainee to wet the BCD strap with | 10) Rationale for wetting the strap clearly |
| water | explained |
| 11) Lower BCD down with the strap around | 12) Trainer demonstrated the importance of |
| air tank | the main strap and smaller safety loop on |
| | the BCD |
| 13) Align the top of the air tank with the top | 14) Trainer demonstrated both the correct & |
| of the BCD handle | incorrect height |
| 15) Ensure the air tank valve control points | 16) Correct alignment of the BCD and valve |
| to the right side of the BCD | control demonstrated |
| 17 Teach trainee how to tighten the strap | 18 Trainee was supervised tightening the |
| and close the buckle | strap and closing the buckle |
| 19) Instruct trainee to lift the BCD by its | 20) Trainer ensured the trainee tested the |
| handle to make sure the air tank does not | BCD-air tank connection |
| slip | |
| 21) Instruct the trainee to place the first | 22) Trainer demonstrated and assisted the |
| stage over the tank valve | trainee with the correct orientation and |
| | positioning of the first stage on the tank |
| | valve |
| 23) Instruct the trainee to position the first | 24) Trainer demonstrated the correct |
| stage filter against the O-ring | positioning of the first stage with the O-ring |
| 25) Teach the trainee to ensure the second | 26) Trainer ensured the trainee correctly |
| stage is on the same side as the valve | aligned the second stage and valve control |
| control | without completing the task for trainee |
| 27) Teach trainee to tighten the yoke screw | 28) Trainer ensured the trainee correctly |
| against the valve (finger tight only). | tightened the yoke screw and valve without |
| | completing the task for the trainee |
| 29) Teach the trainee how to attach the low | 30) Trainer demonstrates the method for |
| pressure hose to the BCD inflator's air inlet | connecting and disconnecting the pressure |
| | hose to the BCD inflator air inlet without |
| | completing the task for the trainee |

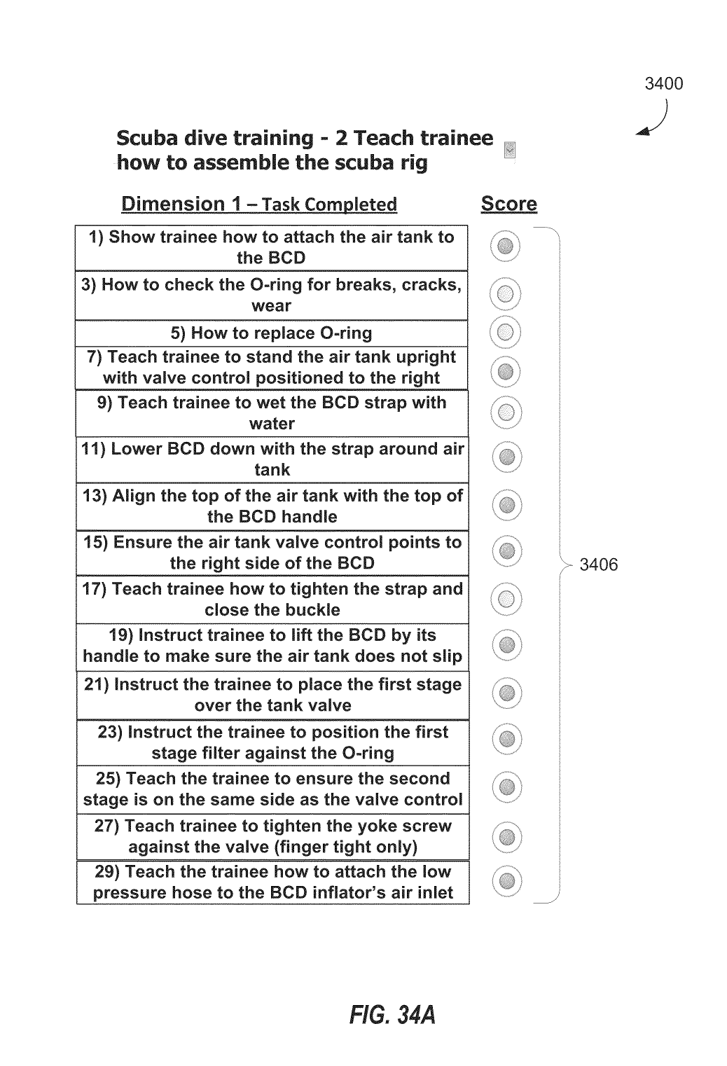

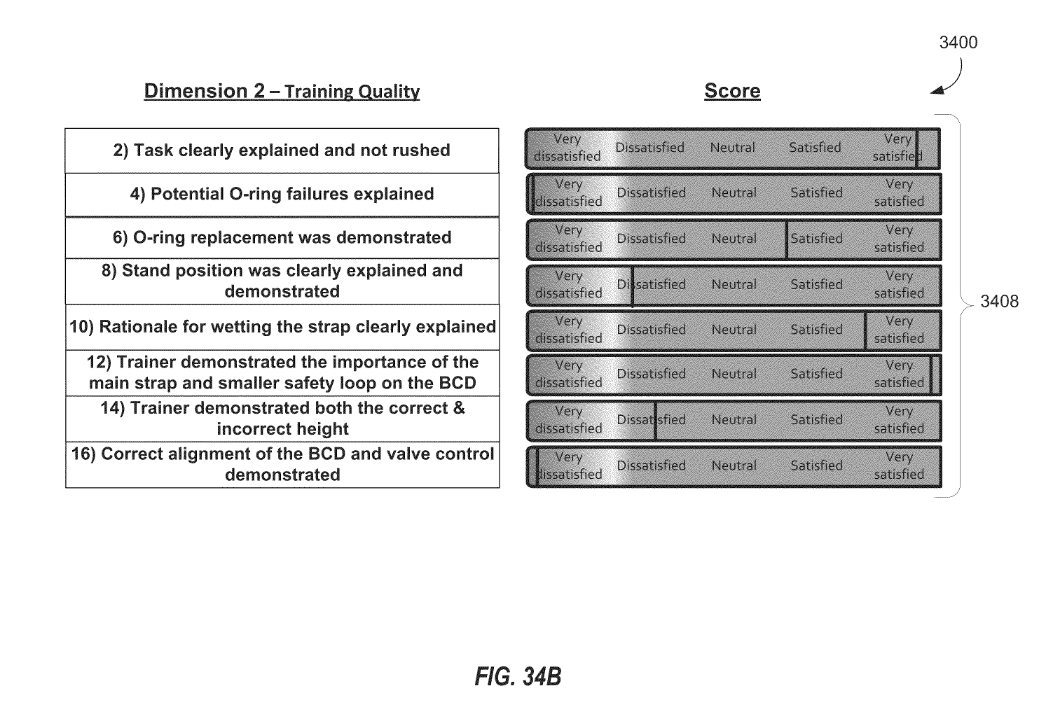

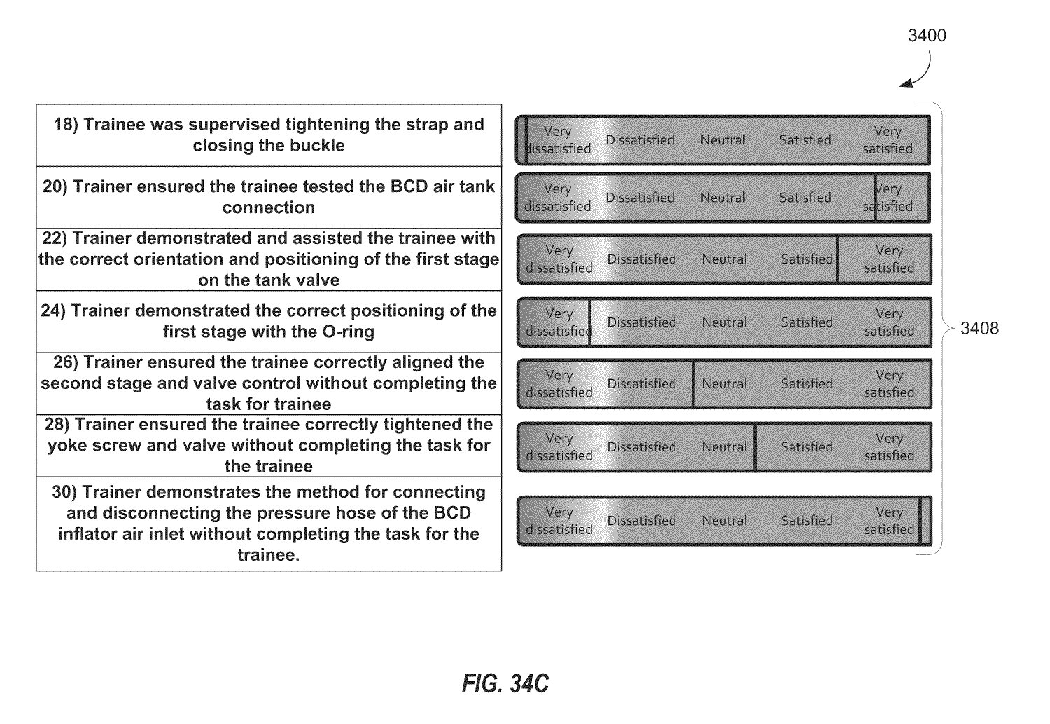

Accordingly, in some embodiments, based on the performance assessment criteria identified above in Table 3, it may be possible to create an AT 3400, the components of which are shown in FIGS. 34A-C.

As shown in FIGS. 34A-C, in some embodiments, an AT 3400 can utilize two different scoring systems. For Dimension 1, as shown in FIG. 34A and which relates to task completed criteria, a binary yes/no option can be utilized with a ‘radio button’ control 3406. Further, in some embodiments, for Dimension 2, as shown in FIGS. 34B and 34C and which relates to training quality, a graphic rating scale with sliding bar control 3408 can be utilized. As will be appreciated, depending on the criteria being assessed, it may be advantageous to utilize different scoring systems. For example, in the foregoing example, the primary objective of the Dimension 1 criteria was to evaluate whether the task was completed by the trainer or not. In such an instance, a yes/no response may suffice. The primary objective of the Dimension 2 criteria was to determine a subjective rating of the trainer's delivery of the associated training task. Thus, a sliding scale may be appropriate to properly evaluate the degree to which the criteria was met.

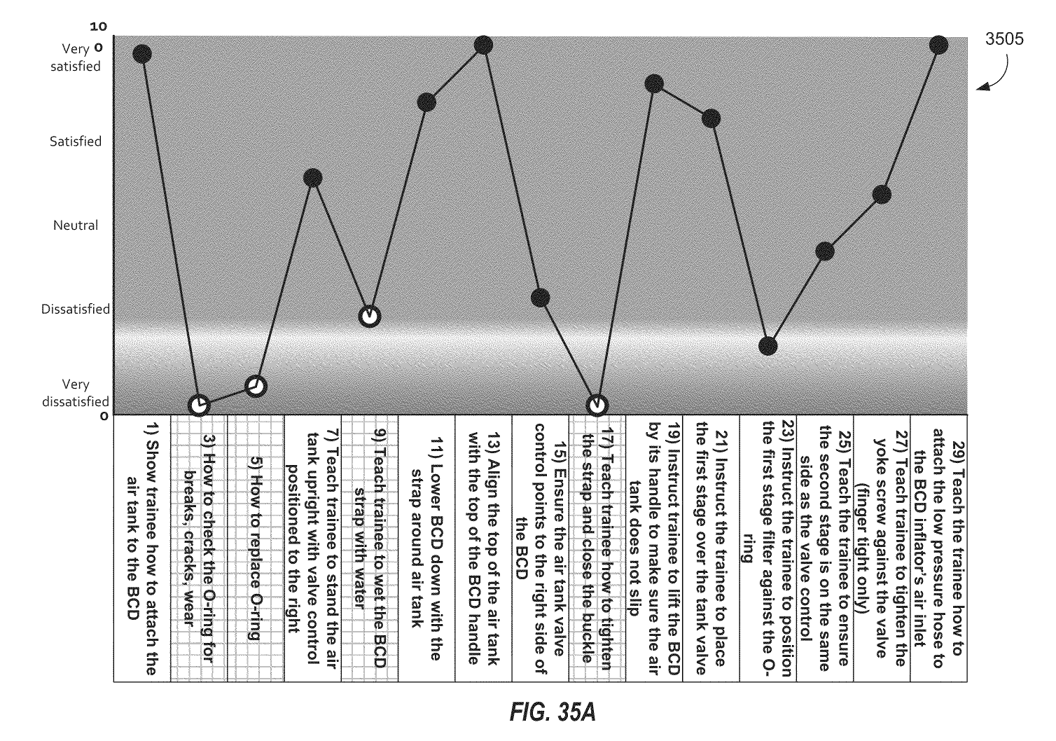

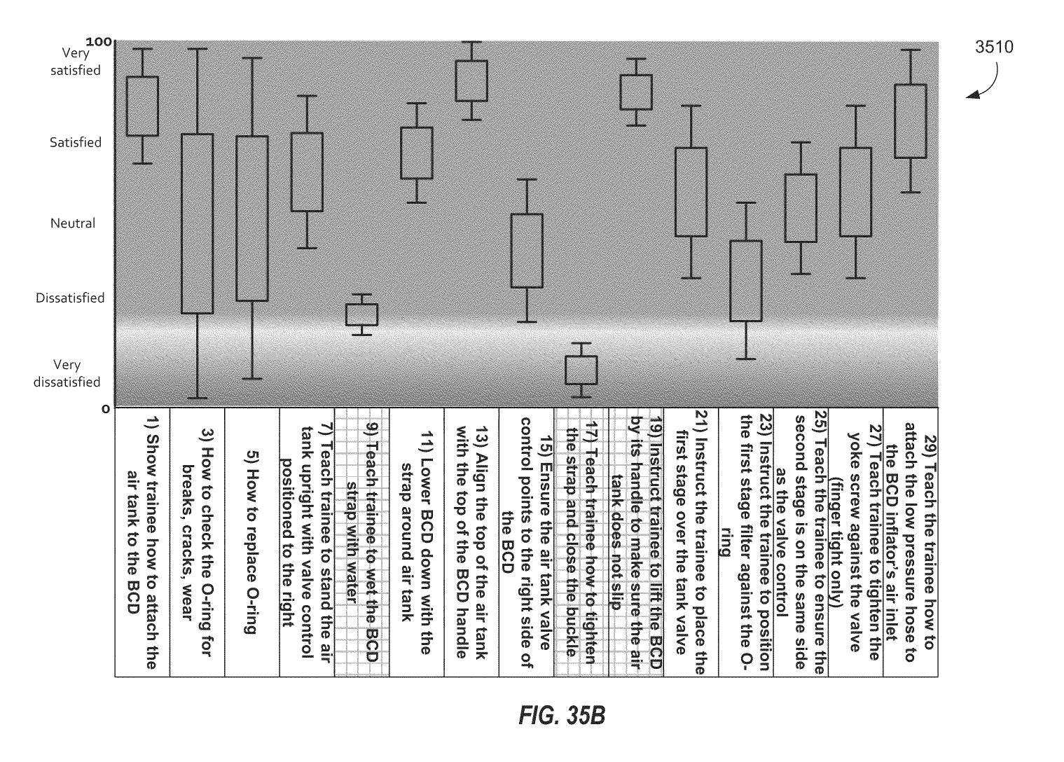

FIGS. 35A and 35B show display results for the assessment discussed in relation to FIG. 34, according to some embodiments. FIG. 35A is a graph 3505 that presents the data for an individual assessment result, where successful tasks are shown by a solid dot and unsuccessful tasks are shown with a hollow dot, and the trainee's perceived satisfaction with the training provided for each task identified by the location of the dot relative to the y-axis scale (very dissatisfied at the bottom to very satisfied at the top). In the plot, it can be seen that unsuccessful tasks were rated ‘Very dissatisfied’ or ‘Dissatisfied’, but so were some of the successful tasks. It is possible that trainees might perceive a task as being completed but were not satisfied with the performance of the service operator or provider for that task. While it is unlikely that a trainee would rate an unsuccessfully completed task as ‘Satisfied’ or ‘Very Satisfied’, it is possible that they might do so if they perceived the utility, value or benefit of that task to be low. This would indicate that the process may need to be revised to optimize it and ensure the utmost value and benefit to trainees.

FIG. 35B is a plot 3510 that shows average results for the same assessment, for the same trainer, over a seven-day period, according to some embodiments. As shown in plot 3510, a a box-and-whisker plot can be used to illustrate trainee satisfaction as gleaned from the assessment results. As will be appreciated, a box-and-whisker plot can illustrate how the trainer is performing over time for each individual task, based on the trainee's perception of the training quality delivered.

### Real-Time and Historical Display

As discussed, in some embodiments, assessment results can be reviewed on a case-by-case basis or over a period of time. Further, an assessor or other reviewer can make comparisons based on whichever AT is used for the assessment, thus allowing for like-with-like comparisons. In some embodiments, assessment results can be color-coded to help distinguish the individual's or group's results. In some embodiments, results can be presented showing the individual's or group's performance relative to their peers in the local environment, or if working in a larger environment. As will be appreciated, such an information display supports assessors in understanding the competency and proficiency levels of operators, which may help ensure that the necessary skills mix is available within the team, group, or organization.

The assessment data and tracking dashboard can also be used to identify operators who need to be re-certified, if, for example, certification is valid only for a specific period of time. For example, in some embodiments, a system of the present disclosure can generate pop-up alerts within the system to alert management or assessors about the need to re-assess and re-certify as applicable. In some embodiments, the system can alert managers, leadership, trainers, assessors, or credentialing entities to new staff members who have just been registered on the technology system and will need assessment and certification. As will be understood and appreciated, the system therefore allows for accurate tracking of operators' competency and proficiency against a set of predefined, objective and codified criteria for specific tasks, activities or processes.

As will be appreciated, once received at a central server or other computing device, assessments and their related information, as disclosed herein, can be recorded immediately into the individual's electronic personnel file or record and/or could be added to a hardcopy record at a later time. In general, such assessments could indicate not only the individual's competence, but also potential need for re-assessment or re-training if the certification is limited to a set period of time, as is often the case in high-risk environments (e.g., aviation, power generation, healthcare, etc.).

### Example IT Process

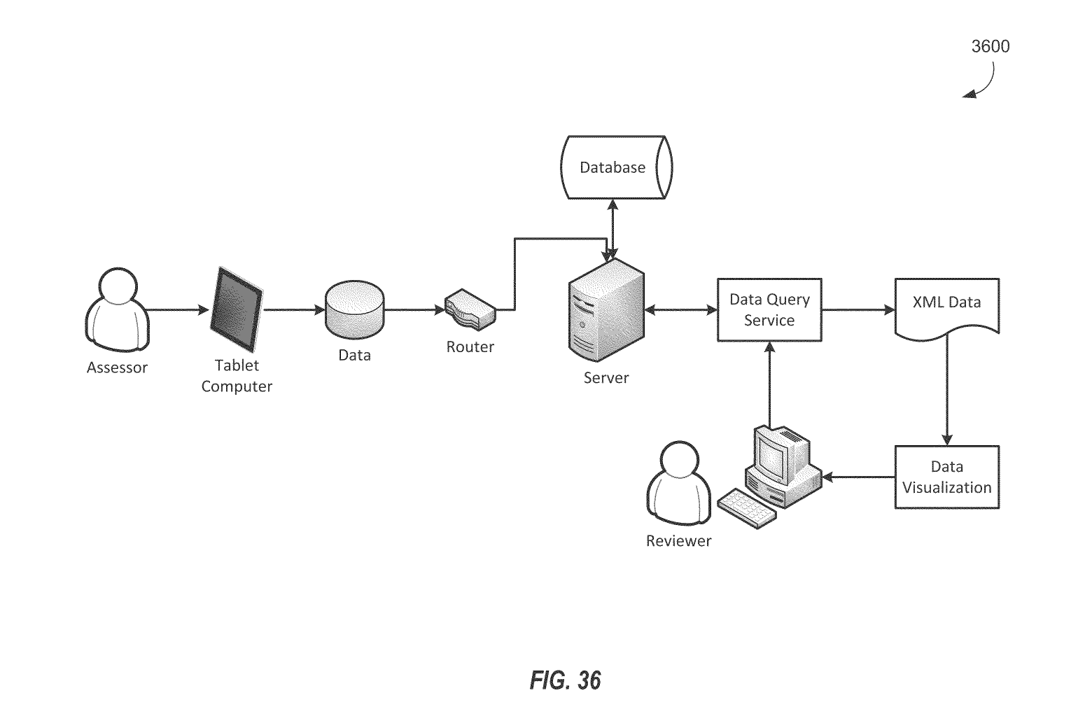

FIG. 36 shows an example process 3600 for assessing an operator using a tablet computer and for displaying the results to a reviewer, who may be the operator being evaluated or a manager, leader, trainer, assessor, or credentialing entity, according to some embodiments. In some embodiments, assessment data recorded on the tablet computer may be sent to a router, typically using a wireless data connection. The data may then be stored in a database on a server. To review the data, the reviewer may open the system interface on a computer, or again on a tablet computer, and query the database for the data, which may be returned in some configurations as XML data and configured for display on the system. As will be understood and appreciated, process 3600 and the related description are intended to be exemplary and in no way limiting.

Embodiments of the subject matter and the functional operations described in this specification can be implemented in digital electronic circuitry, or in computer application, firmware, or hardware, including the structures disclosed in this specification and their structural equivalents, or in combinations of one or more of them. Embodiments of the subject matter described in this specification can be implemented as one of more computer program products, i.e. one of more modules of computer program instructions encoded on a computer-readable medium for execution, by or to control the operation of, data processing apparatus. The computer-readable medium can be a machine-readable storage device, a machine-readable storage substrate, a memory device, or a combination of cone or more of them.

A computer program (also known as a program, application, or script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g. one or more scripts stored in an XML or a markup language document), in a single file dedicated to the program in question, or in multiple coordinated files (e.g. files that store one or more modules, sub-programs, or portions of code). A computer program can be deployed to be executed on one computer or on multiple computers that are located at one site or distributed across multiple sites and interconnected by a communication network.

The process and logic flows described in this specification can be performed by one or more programmable processors executing one or more computer programs to perform functions by operating on input data and generating output. The processes and logic flow can also be performed by, and apparatus can also be implemented as, special purpose logic circuitry, e.g. a Field Programmable Gate Array (FPGA) or an Application-Specific Integrated Circuit (ASIC).

Processors suitable for the execution of a computer program include, by way of example, both general and special purpose microprocessors, and any one or more processors of any kind of digital computer. Generally, a processor will receive instructions and data from a read-only memory or a random access memory or both. Generally, the essential elements of a computer are a processor for performing instructions and one or more memory devices for storing instructions and data. Generally, a computer will also include, or be operatively coupled to receive data from or transfer data to, or both, one or more mass storage devices for storing data, e.g. magnetic, magneot-optical disks, or optical disks. However, a computer can be embedded in another, e.g. a mobile telephone, a tablet computer, a personal digital assistant (PDA), a mobile audio player, a Global Positioning System (GPS) receiver, to name just a few. Computer-readable media suitable for storing computer program instructions and data include all forms of non-volatil memory, media and memory devices, including by way of example semiconductor memory devices, e.g. EPROM, EEPROM and flash memory devices; magnetic disks, e.g. internal hard disks or removalbe disks; magneto-optical disks; and CD-ROM and DVD-ROM disks. The processor and the memory can be supplemented by, or incorporated in, special purpose logic circuitry.

To provide for interaction with a operator, embodiments of the subject matter described in this specification can be implemented on a computer having a display device, e.g. a Cathode Ray tube (CRT), Liquid Crystal Display (LCD), Light Emitting Diode (LED), Active-Matrix Organic Light-Emitting Diode (AMOLED) monitor, or other suitable viewing device, for displaying information to the operator, and a keyboard and a pointing device, e.g. a mouse or a trackball, by which the operator can provide input to the computer. Other kinds of devices can be used to provide for interaction with or form the operator; for example, feedback to the operator can be any form of sensory feedback, e.g. visual, auditory or tactile; and input from the operator can be received in any form including acoustic, speech, or tactile, e.g. a touch-screen may be utilized that displays information and receives input from the operator, using any form of touch-sensitive technology including but not limited to resistive, surface acoustic wave, capacitive, infrared grid, infrared acrylic projection, optical imaging, dispersive signal technology or acoustic pulse recognition.

Embodiments of the subject matter described in this specification can be implemented in a computing system that includes a back-end component, e.g. as a data server or that includes a middleware component, e.g. an application server or that includes a front-end component, e.g. a client computer having a graphical operator interface or Web browser through which a operator can interact with an implementation of the subject matter described in this specification or any combination of one or more such back-end, middleware or front-end components. The components of the system can be interconnected by any form or medium of digital data communication, e.g. a communication network. Examples of communication networks include a Local Area Netowrk (LAN) and a Wide Area Network (WAN), e.g. the Internet.

The computing system can include clients and servers. A client and server are generally remote from each other and typically interact through a communication netowrk. The relationship of client an server arises by virtue of computer programs running on the respective computers and having a client-server relationship to each other. Aspects of the disclosed technology can be performed at a server computer, including a cloud server, as well as at a personal computing device including a desktop or laptop computer, or a mobile computing device such as a tablet computer, smartphone, or other mobile computing device.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combinatino in a single embodiment. Conversely, various features that are described in the context of a single embodiment can also be implemented in multiple embodiments separately or in any suitable subcombination. Moreover, although features may be described above as acting in certain combinations and even initially claimed as such, one of more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments and it should be understood that the described program components and systems can generally be integrated together in a single appliation product or packaged into multiple application products.

Thus, particular embodiments of the invention have been described. Other emboidments are with the scope of the following claims. For example, the actions recited in the claims can be performed in a different order and still achieve desirable results.

What is claimed is:

1. A method, comprising:
responsive to receiving, by a processor, one or more performance related criteria, the one or more performance related criteria relating to an individual's performance of a particular task, generating, by the processor, an assessment template, the assessment template comprising information indicative of the one or more performance related criteria;
outputting, by the processor and for display at a computing device, the assessment template;
receiving, by the processor and from the computing device, information indicative of one or more responses relating to the one or more performance related criteria;
storing, in a database associated with the processor, the information indicative of one or more responses relating to the one or more performance related criteria;
responsive to receiving, by the processor and from the computing device, an indication of a request for a results dashboard, generating, by the processor, the results dashboard; and
outputting, by the processor and for display at the computing device, the results dashboard.

2. The method of claim 1, wherein the results dashboard comprises the information indicative of the one or more responses relating to the one or more performance related criteria.

3. The method of claim 1, wherein the computing device is a first computing device, and wherein information indicative of one or more responses relating to the one or more performance related criteria is first information indicative of one or more responses relating to the one or more performance related criteria, and wherein prior to generating the results dashboard, the method further comprises:
outputting, by the processor and for display at a second computing device, the assessment template;
receiving, by the processor and from the second computing device, second information indicative of one or more responses relating to the one or more performance related criteria;
storing, in the database, the second information indicative of one or more responses relating to the one or more performance related criteria; and
aggregating, by the processor, the first and second information indicative of one or more responses relating to the one or more performance related criteria into aggregated response information indicative of the one or more responses relating to the one or more performance related criteria received from the first and second computing devices.

4. The method of claim 3, wherein the dashboard comprises the aggregated response information.

5. The method of claim 1, wherein the information indicative of one or more responses relating to the one or more performance related criteria relates to an individual and wherein the database stores a profile associated with the individual, and wherein prior to generating the results dashboard, the method further comprises:
associating, in the database, the information indicative of one or more responses relating to the one or more performance related criteria to the profile associated with the individual.

6. The method of claim 1, wherein information indicative of one or more responses relating to the one or more performance related criteria includes audiovisual content.

7. A system, comprising:
one or more processors;
a memory coupled to the one or more processors and storing instructions that, when executed by the one or more processors, cause the system to:
receive one or more performance related criteria, the one or more performance related criteria relating to an individual's performance of a particular task;
generate an assessment template, the assessment template comprising information indicative of the one or more performance related criteria;
output, for display at a computing device, the assessment template;
receive, from the computing device, information indicative of one or more responses relating to the one or more performance related criteria;
store the information indicative of one or more responses relating to the one or more performance related criteria;
receive, from the computing device, an indication of a request for a results dashboard;
generate the results dashboard; and
output, for display at the computing device, the results dashboard.

8. The system of claim 7, wherein the results dashboard comprises the information indicative of the one or more responses relating to the one or more performance related criteria.

9. The system of claim 7, wherein the computing device is a first computing device, and wherein information indicative of one or more responses relating to the one or more performance related criteria is first information indicative of one or more responses relating to the one or more performance related criteria, the memory storing instructions that, when executed by the one or more processors, further cause the system, prior to generating the results dashboard, to:
output, for display at a second computing device, the assessment template;
receive, from the second computing device, second information indicative of one or more responses relating to the one or more performance related criteria;
store the second information indicative of one or more responses relating to the one or more performance related criteria; and
aggregate the first and second information indicative of one or more responses relating to the one or more performance related criteria into aggregated response information indicative of the one or more responses relating to the one or more performance related criteria received from the first and second computing devices.

10. The system of claim 9, wherein the dashboard comprises the aggregated response information.

11. The system of claim 7, wherein the information indicative of one or more responses relating to the one or more performance related criteria relates to an individual and wherein the system stores a profile associated with the individual, the memory storing instructions that, when executed by the one or more processors, further cause the system, prior to generating the results dashboard, to:
associate the information indicative of one or more responses relating to the one or more performance related criteria to the profile associated with the individual.

12. The system of claim 7, wherein information indicative of one or more responses relating to the one or more performance related criteria includes audiovisual content.

13. A non-transitory computer-readable medium storing instructions that, when executed by one or more processors, cause a first computing device to:
receive one or more performance related criteria, the one or more performance related criteria relating to an individual's performance of a particular task;
generate an assessment template, the assessment template comprising information indicative of the one or more performance related criteria;
output, for display at a second computing device, the assessment template;
receive, from the second computing device, information indicative of one or more responses relating to the one or more performance related criteria;
store the information indicative of one or more responses relating to the one or more performance related criteria;
receive, from the second computing device, an indication of a request for a results dashboard;
generate the results dashboard; and
output, for display at the second computing device, the results dashboard.

14. The non-transitory computer-readable medium of claim 13, wherein the results dashboard comprises the information indicative of the one or more responses relating to the one or more performance related criteria.

15. The non-transitory computer-readable medium of claim 13, wherein information indicative of one or more responses relating to the one or more performance related criteria is first information indicative of one or more responses relating to the one or more performance related criteria, the non-transitory computer-readable medium storing instructions that, when executed by the one or more processors, further cause the first computing device, prior to generating the results dashboard, to:
output, for display at a third computing device, the assessment template;
receive, from the third computing device, second information indicative of one or more responses relating to the one or more performance related criteria;
store the second information indicative of one or more responses relating to the one or more performance related criteria; and
aggregate the first and second information indicative of one or more responses relating to the one or more performance related criteria into aggregated response information indicative of the one or more responses relating to the one or more performance related criteria received from the second and third computing devices.

16. The non-transitory computer-readable medium of claim 15, wherein the dashboard comprises the aggregated response information.

17. The non-transitory computer-readable medium of claim 13, wherein the information indicative of one or more responses relating to the one or more performance related criteria relates to an individual and wherein the first computing device stores a profile associated with the individual, the non-transitory computer-readable medium storing instructions that, when executed by the one or more processors, further cause the first computing device, prior to generating the results dashboard, to:
associate the information indicative of one or more responses relating to the one or more performance related criteria to the profile associated with the individual.

18. The non-transitory computer-readable medium of claim 13, wherein information indicative of one or more responses relating to the one or more performance related criteria includes audiovisual content.
